(19) United States
(12) Patent Application Publication
(10) Pub. No.: US 2016/0358267 A1
(43) Pub. Date: Dec. 8, 2016

(54) MACHINE/ARTICLE/COMPOSITION/PROCESS STATE(S) FOR TRACKING PHILANTHROPIC AND/OR OTHER EFFORTS

(71) Applicant: Elwha LLC, Bellevue, WA (US)

(72) Inventors: Ali Arjomand, Yarrow Point, WA (US); Kim Cameron, Seattle, WA (US); William Gates, Medina, WA (US); Roderick A. Hyde, Redmond, WA (US); Muriel Y. Ishikawa, Livermore, CA (US); Jordin T. Kare, San Jose, CA (US); Max R. Levchin, San Francisco, CA (US); Nathan P. Myhrvold, Medina, WA (US); Tony S. Pan, Bellevue, WA (US); Aaron Sparks, Bellevue, WA (US); Russ Stein, Bellevue, WA (US); Clarence T. Tegreene, Mercer Island, WA (US); Maurizio Vecchione, Pacific Palisades, CA (US); Lowell L. Wood, JR., Bellevue, WA (US); Victoria Y.H. Wood, Livermore, CA (US)

(21) Appl. No.: 15/055,515

(22) Filed: Feb. 26, 2016

Related U.S. Application Data
(60) Provisional application No. 62/170,127, filed on Jun. 2, 2015.
(60) Provisional application No. 62/233,248, filed on Sep. 25, 2015.
(60) Provisional application No. 62/235,459, filed on Sep. 30, 2015.
(60) Provisional application No. 62/239,816, filed on Oct. 9, 2015.
(60) Provisional application No. 62/241,730, filed on Oct. 14, 2015.
(60) Provisional application No. 62/188,277, filed on Jul. 2, 2015.

(51) Int. Cl. G06Q 40/00; G06Q 20/06; G06Q 30/02

(52) U.S. Cl. CPC G06Q 40/12; G06Q 30/0279; G06Q 20/065

(57) ABSTRACT

A method substantially as shown and described the detailed description and/or drawings and/or elsewhere herein. A device substantially as shown and described the detailed description and/or drawings and/or elsewhere herein.

### CROSS-REFERENCE TO RELATED APPLICATIONS

Unless specifically excepted, all subject matter of the herein listed application(s) and of any and all parent, grandparent, great-grandparent, etc. applications of the herein listed applications, including any priority claims, is incorporated herein by reference to the extent such subject matter is not inconsistent herewith.

Unless specifically excepted, the present application is related to and/or claims the benefit of the earliest available effective filing date(s) from/through the application(s) if any, listed herein (e.g., claims earliest available priority dates for other than provisional patent applications, or claims benefits under 35 USC §119(e) for provisional patent applications, for any and all parent, grandparent, great-grandparent, etc. applications of the listed applications.

For purposes of the USPTO extra-statutory requirements, the present application claims benefit of priority of U.S. Provisional Patent Application No. 62/170,127, naming William Gates, Max R. Levchin, Nathan P. Myhrvold, Clarence T. Tegreene, and Lowell L. Wood, Jr. as inventors, filed 2 Jun. 2015, which was filed within the twelve months preceding the filing date of the present application or is an application of which a currently co-pending application is entitled to the benefit of the filing date.

For purposes of the USPTO extra-statutory requirements, the present application claims benefit of priority of U.S. Provisional Patent Application No. 62/233,248, naming Clarence T. Tegreene as inventor, filed 25 Sep. 2015, which was filed within the twelve months preceding the filing date of the present application or is an application of which a currently co-pending application is entitled to the benefit of the filing date.

For purposes of the USPTO extra-statutory requirements, the present application claims benefit of priority of U.S. Provisional Patent Application No. 62/235,459, naming Clarence T. Tegreene as inventor, filed 30 Sep. 2015, which was filed within the twelve months preceding the filing date of the present application or is an application of which a currently co-pending application is entitled to the benefit of the filing date.

For purposes of the USPTO extra-statutory requirements, the present application claims benefit of priority of U.S. Provisional Patent Application No. 62/239,816, naming Clarence T. Tegreene as inventor, filed 9 October 2015, which was filed within the twelve months preceding the filing date of the present application or is an application of which a currently co-pending application is entitled to the benefit of the filing date.

For purposes of the USPTO extra-statutory requirements, the present application claims benefit of priority of U.S. Provisional Patent Application No. 62/241,730, naming Clarence T. Tegreene as inventor, filed 14 Oct. 2015, which was filed within the twelve months preceding the filing date of the present application or is an application of which a currently co-pending application is entitled to the benefit of the filing date.

For purposes of the USPTO extra-statutory requirements, the present application claims benefit of priority of U.S. Provisional Patent Application No. 62/265,941, naming Clarence T. Tegreene as inventor, filed 10 Dec. 2015, which was filed within the twelve months preceding the filing date of the present application or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter

“Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to attribution of currency.

### SUMMARY

In one or more various aspects, a method includes but is not limited to that which is illustrated in the drawings. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1-A through 1-L, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1-A through 1-L are stitched together in the manner shown in the below table, which is reproduced below in table format.

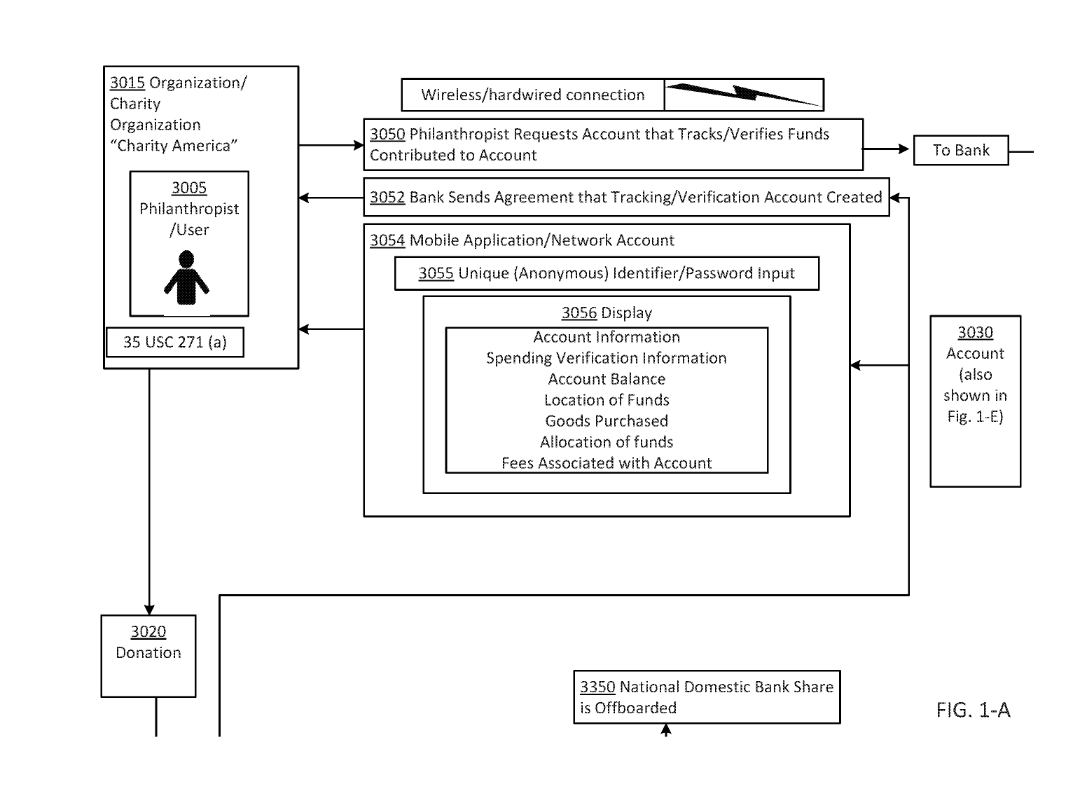

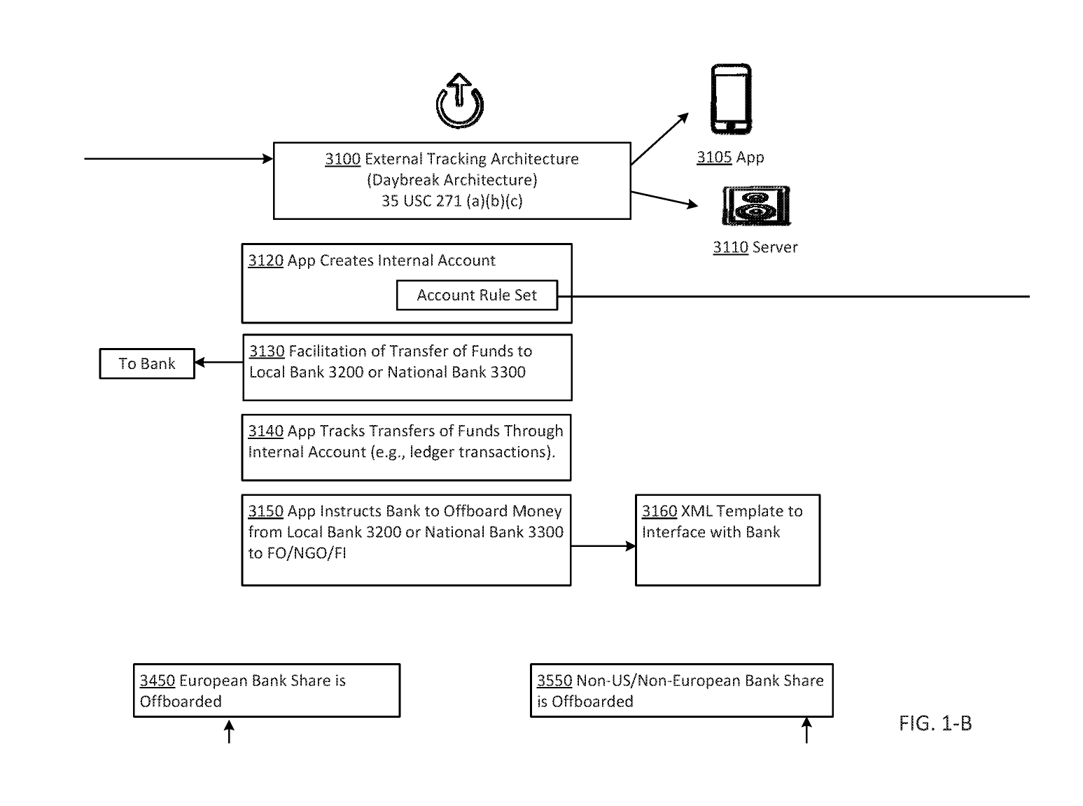

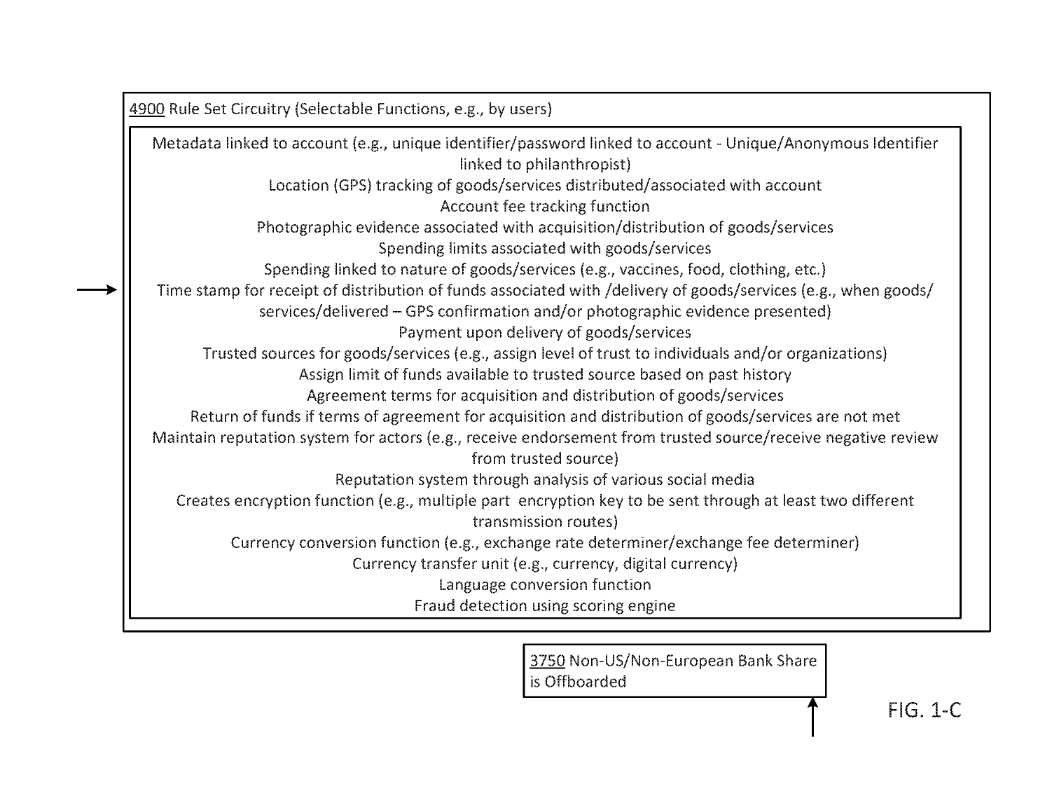

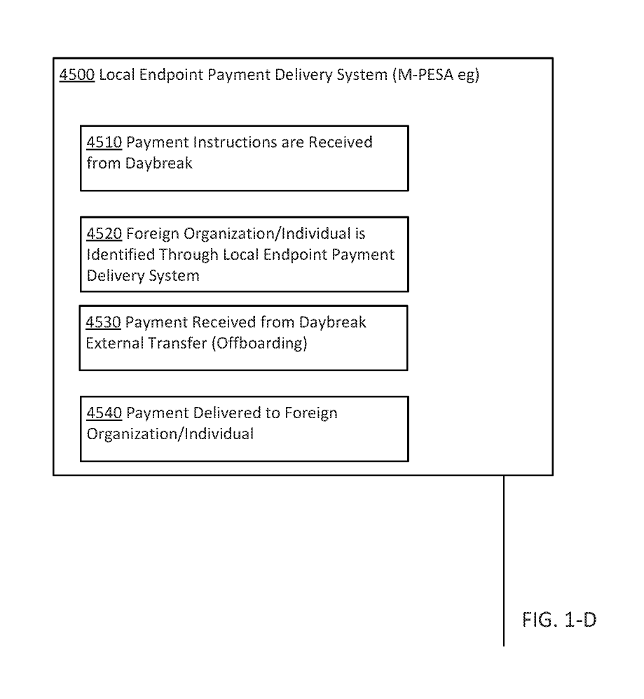

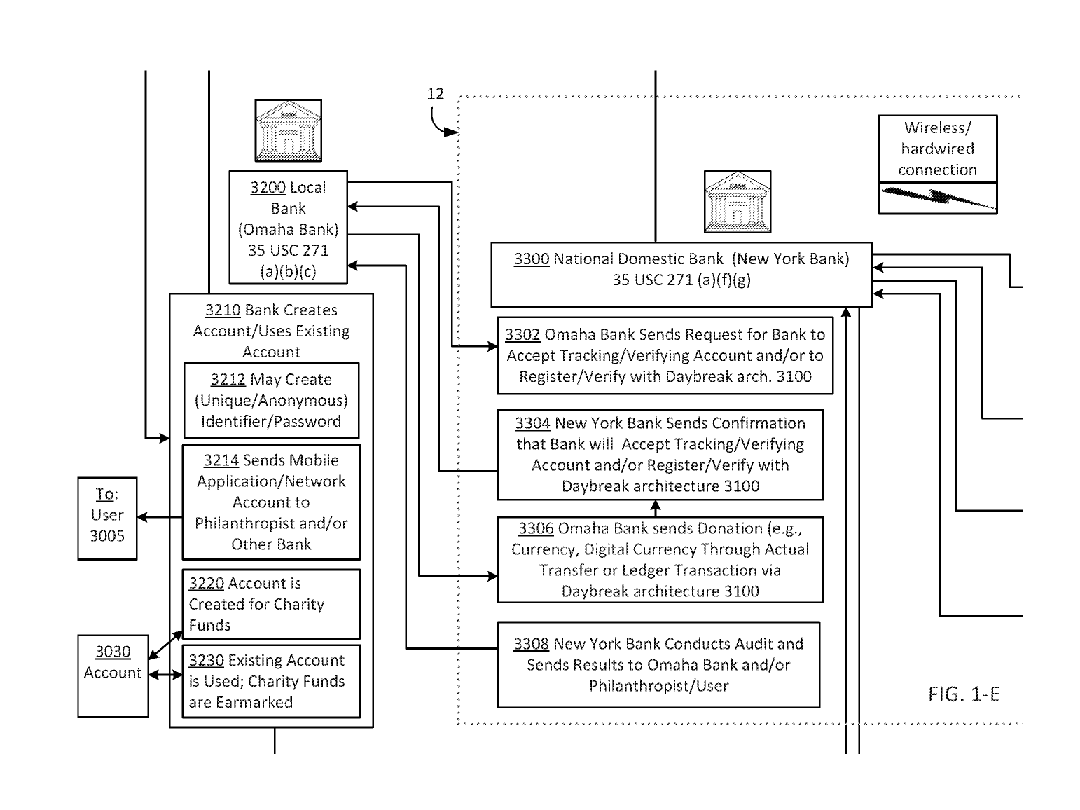

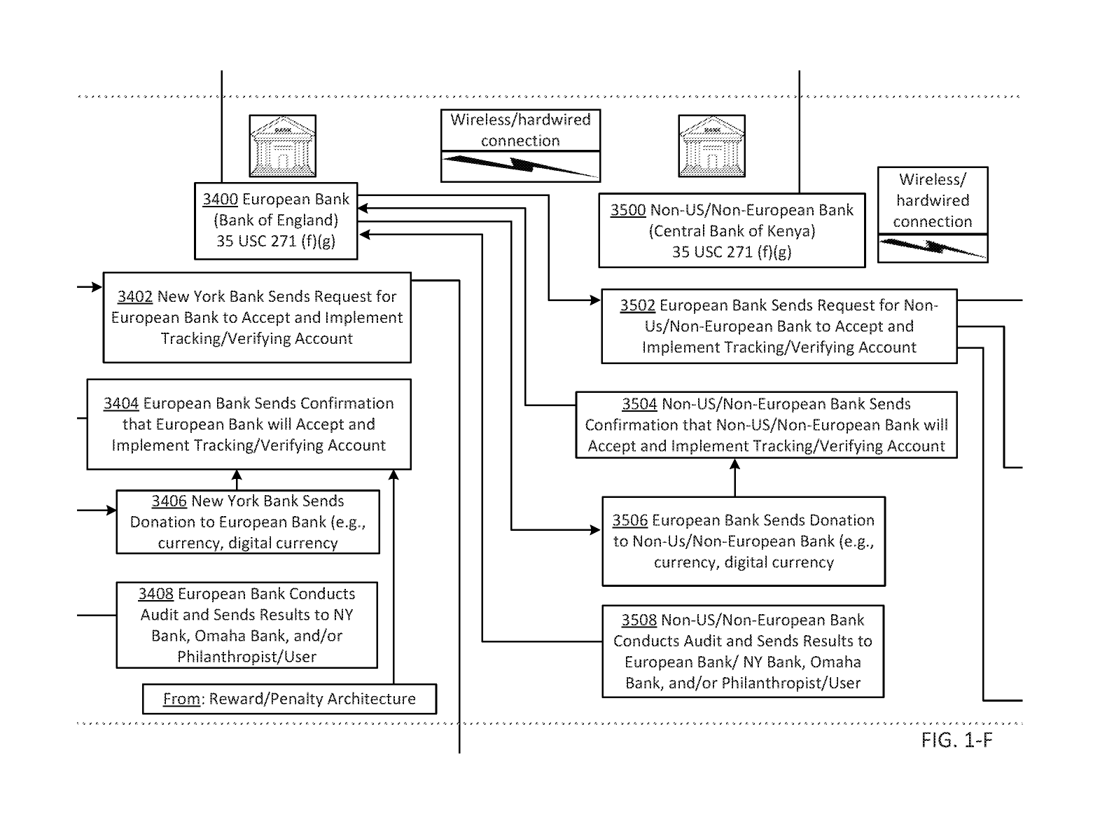

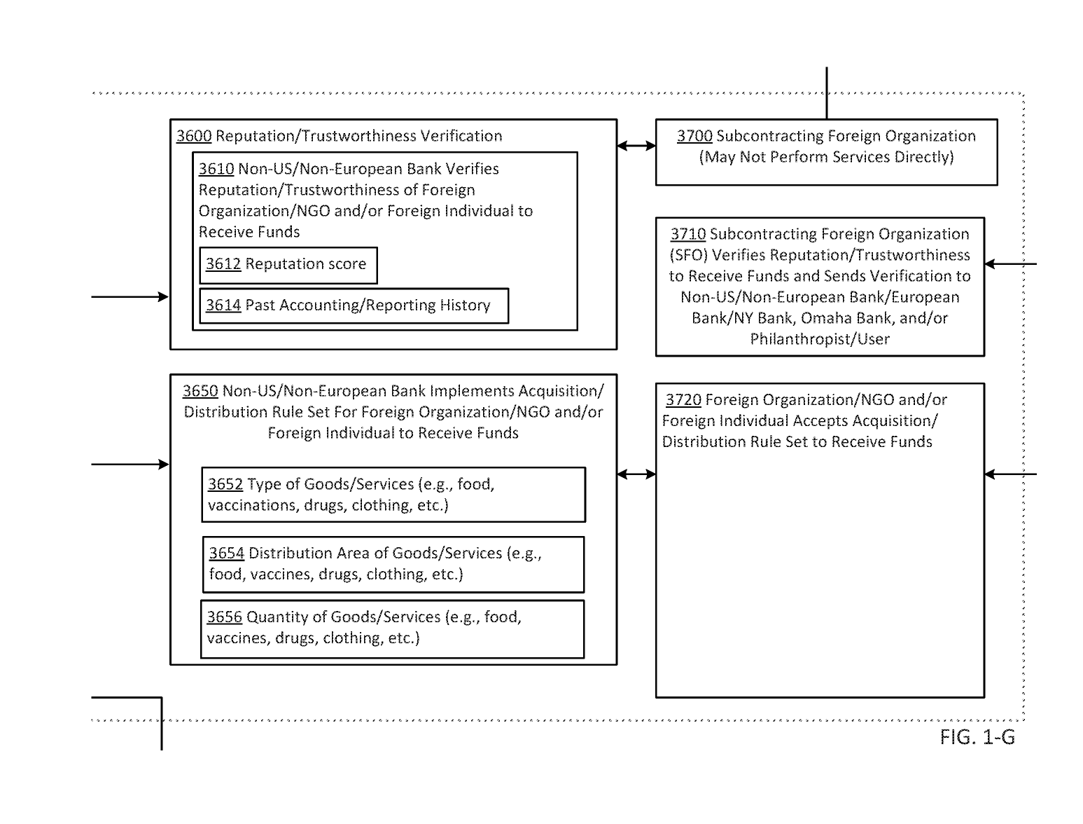

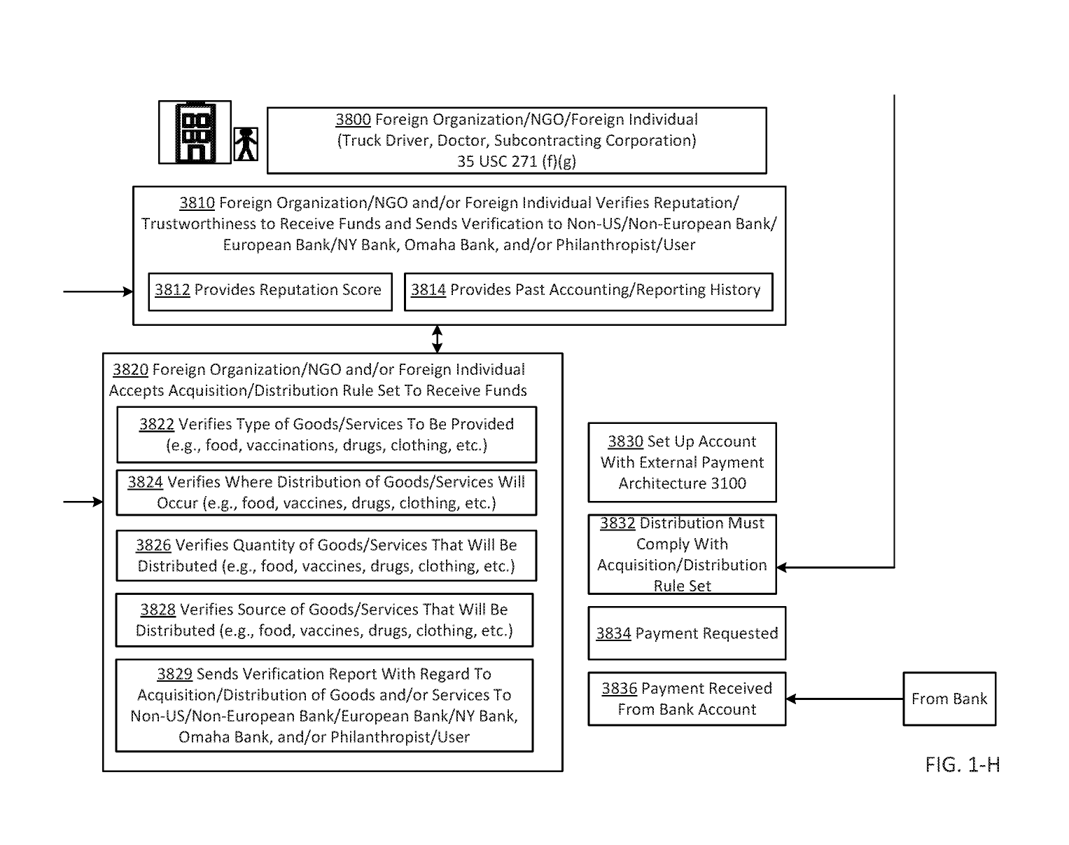

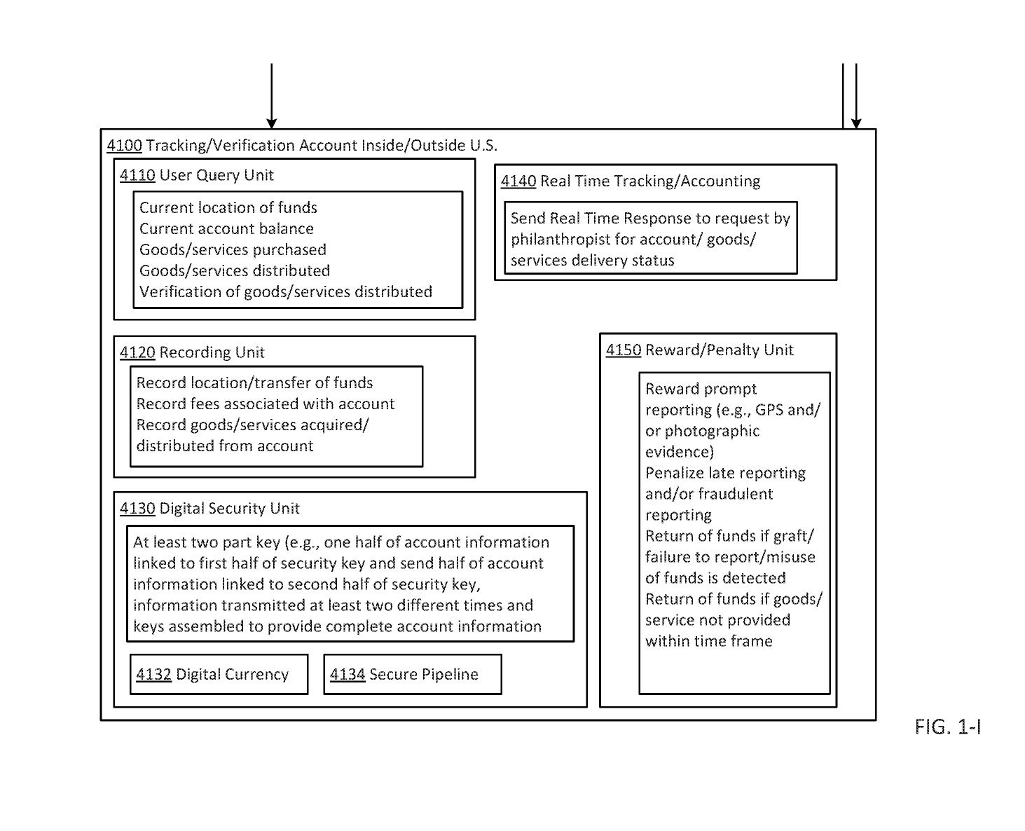

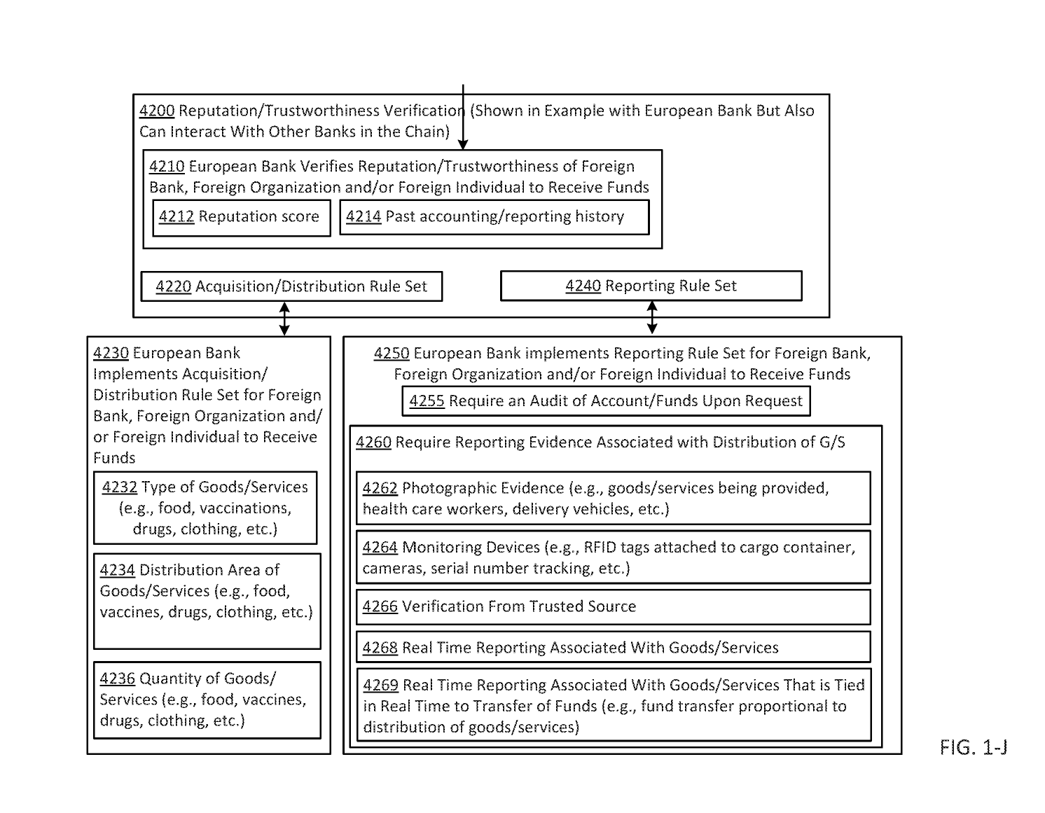

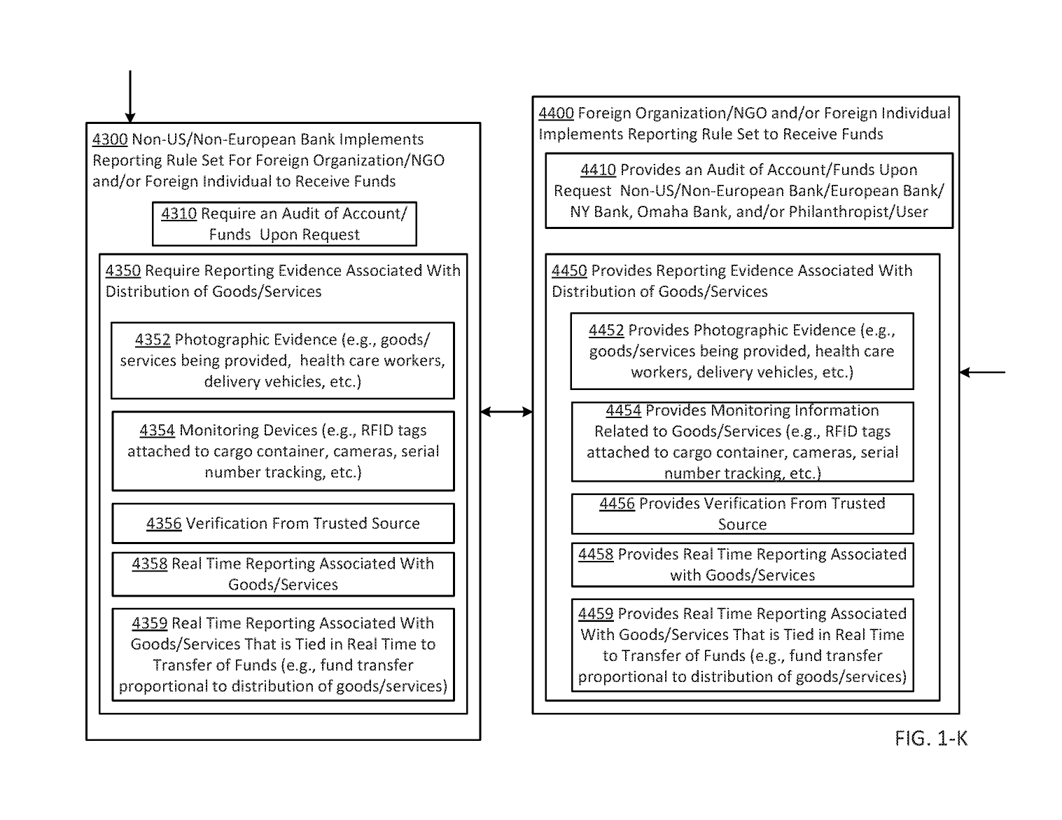

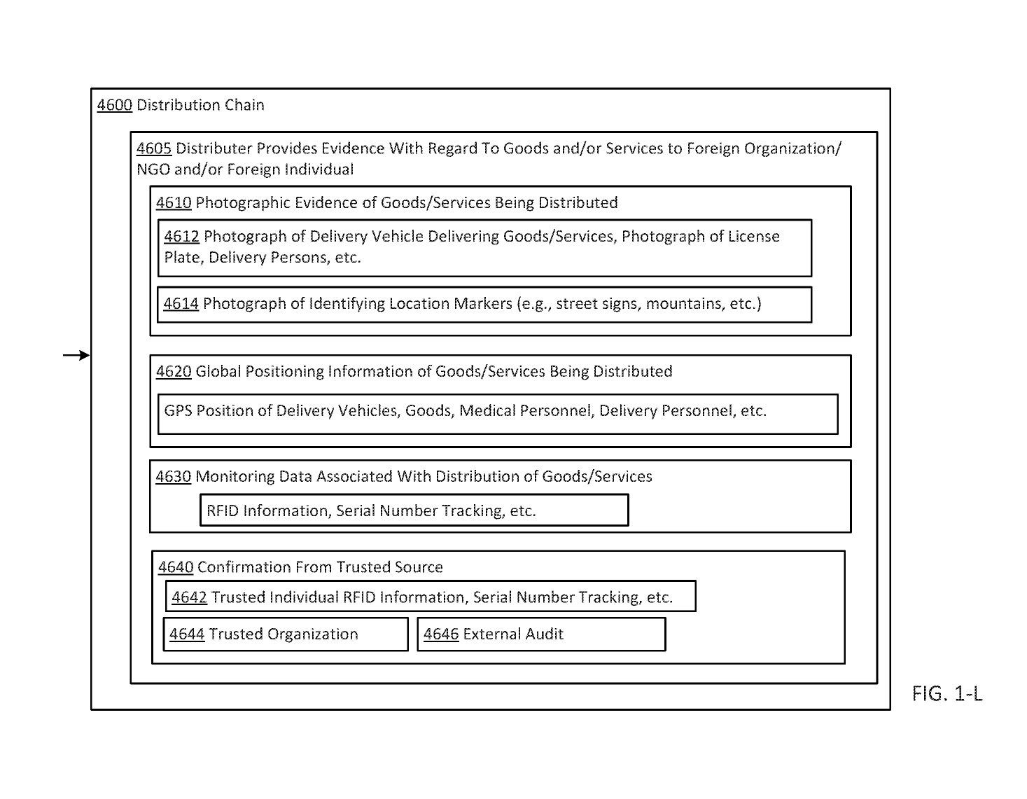

In accordance with 37 C.F.R. §1.84(h)(2), FIG. 1 shows “a view of a large machine or device in its entirety ... broken into partial views . . . extended over several sheets” labeled FIG. 1-A through FIG. 1-L (Sheets 1-12). The “views on two or more sheets form ,in effect, a single complete view, [and] the views on the several sheets ... [are] so arranged that the complete figure can be assembled” from “partial views drawn on separate sheets . . . linked edge to edge. Thus, in FIG. 1, the partial view FIGS. 1-A through 1-L are ordered alphabetically, by increasing in columns from left to right, and increasing in rows top to bottom, as shown in the following table:

TABLE 1
Table showing alignment of enclosed drawings to form
partial schematic of one or more environments.

| Pos. (0,0) | X-Pos 1 | X-Pos 2 | X-Pos 3 | X-Pos 4 |
|---|---|---|---|---|
| Y-Pos. 1 | (1,1): | (1,2): | (1,3): | (1,4): |
| | FIG. 1-A | FIG. 1-B | FIG. 1-C | FIG. 1-D |
| Y-Pos. 2 | (2,1): | (2,2): | (2,3): | (2,4): |
| | FIG. 1-E | FIG. 1-F | FIG. 1-G | FIG. 1-H |
| Y-Pos. 3 | (3,1): | (3,2): | (3,3): | (3,4): |
| | FIG. 1-I | FIG. 1-J | FIG. 1-K | FIG. 1-L |

FIG. 1-A, when placed at position (1,1), forms at least a portion of a partially schematic diagram of an environment(s) and/or an implementation(s) of technologies described herein.

FIG. 1-B, when placed at position (1,2), forms at least a portion of a partially schematic diagram of an environment(s) and/or an implementation(s) of technologies described herein.

FIG. 1-C, when placed at position (1,3), forms at least a portion of a partially schematic diagram of an environment(s) and/or an implementation(s) of technologies described herein.

FIG. 1-D, when placed at position (1,4), forms at least a portion of a partially schematic diagram of an environment(s) and/or an implementation(s) of technologies described herein.

FIG. 1-E, when placed at position (2,1), forms at least a portion of a partially schematic diagram of an environment(s) and/or an implementation(s) of technologies described herein.

FIG. 1-F, when placed at position (2,2), forms at least a portion of a partially schematic diagram of an environment(s) and/or an implementation(s) of technologies described herein.

FIG. 1-G, when placed at position (2,3), forms at least a portion of a partially schematic diagram of an environment(s) and/or an implementation(s) of technologies described herein.

FIG. 1-H, when placed at position (2,4), forms at least a portion of a partially schematic diagram of an environment(s) and/or an implementation(s) of technologies described herein.

FIG. 1-I, when placed at position (3,1), forms at least a portion of a partially schematic diagram of an environment(s) and/or an implementation(s) of technologies described herein.

FIG. 1-J, when placed at position (3,2), forms at least a portion of a partially schematic diagram of an environment(s) and/or an implementation(s) of technologies described herein.

FIG. 1-K, when placed at position (3,3), forms at least a portion of a partially schematic diagram of an environment(s) and/or an implementation(s) of technologies described herein.

FIG. 1-L, when placed at position (3,4), forms at least a portion of a partially schematic diagram of an environment(s) and/or an implementation(s) of technologies described herein.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for the environment illustrated in FIG. 1.

Operational Descriptions are Not Abstract Ideas But Are A Specification for Massively Complex Computational Machines

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of June 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around -5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructionsper second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc..), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### FIG. 1—System Overview

Referring now to FIG. 1, FIG. 1 shows various implementations of the overall system. At a high level, FIG. 1 shows various implementations of an attributed digital currency system, in all of its parts. The boxes of FIG. 1 are not labeled as “modules” or “circuits” or “steps” because one of skill in the art would understand that the differences are matters of conventional implementation. There exist automated tools, for example, VHDL interpreters, for example, Xilinx Vivado (described simply at http://www.xilinx.com/products/design-tools/vivado.l.html). Accordingly, the blocks of FIG. 1 will be herein interchangeably referred to as “panticles,” or “all [pan] articles,” and it will be understood to one of skill in the art that these panticles could be implemented as method steps (e.g., and then converted to FPGAs or ASICs as described above) or as circuit/modules of one or more processors. Nothing in this paragraph should be interpreted as limiting an implementation of various embodiments.

In an embodiment, a philanthropist/user, e.g., user 3005, may be referred to herein for illustrative purposes, interchangeably, as “Charity User.” User 3005 may be connected with an individual charitable organization 3015. It is noted here that, although the words “charitable organization” may appear throughout the specification and disclosure, it is not necessary for the organization in question to be a charitable organization. Although charitable organizations may benefit substantially by the arrangement here, there is no technological limitation for non-charitable organizations that wish to keep their funds in an attributable manner. The “charitable organization” here is used as an exemplary implementation and should not be construed as placing any limitations on the entity using or benefitting from the system. There exist embodiments in which the Daybreak architecture 3100 and the other entities shown in FIG. 1 are used for commercial purposes, or a mix of charitable and/or commercial purposes.

In various embodiments, the individual charitable organization 3015 may be omitted completely. For example, the user/philanthropist may wish to use personal funds that are not tied to an organization. In such an implementation, the user 3005 may communicate directly with their local bank (described in more detail herein) and create the computationally-attributable account on their own.

Referring now to FIG. 1-A, in an embodiment, a charity organization 3015 may request an account, that is account 3030, which, in an embodiment, may be a computationally-attributable account that tracks and/or verifies funds that are contributed to the account 3050. More details about various embodiments of account 3030, which, in an embodiment, may be a computationally-attributable account, will be discussed herein. The request may be sent to the bank, as shown in FIG. 1-A, e.g., local bank 3100 or national domestic bank 3200. In an embodiment, the request for the account 3002 by the philanthropist 3005 may occur in panticle 3050, which may be originated by the philanthropist 3005, the charity organization 3015, or one of the banks 3100 and 3200.

In an embodiment, the bank at which the account 3030 was requested may send an agreement that the computationally-attributable account has been created 3052. This agreement may specify the terms of the account 3030. In an embodiment, the account 3030 may be created at local bank 3200, national domestic bank 3300, or at external tracking architecture 3100 running on external architecture application 3105 (e.g., as shown in FIG. 1-B), which may interface with one or more of the entities in FIG. 1.

In an embodiment, the account 3030 may be associated with a network account and/or a mobile application 3054. The mobile application 3054 may include a unique identifier and/or password input. In an embodiment, the unique identifier may be an anonymous identifier. In another embodiment, the mobile application 3054 may utilize two-factor authentication.

Mobile application 3054 will be discussed in more detail herein, but in an embodiment, mobile application 3054 may include a display panticle 3056. The display panticle 3056 may include various components that allow interaction with a display, e.g., an application back end, a device graphics unit, a screen or other input or output device, and the like. Display panticle 3056 may be configured to show various implementations of the computationally-attributable account, for example all of the horizontal and vertical spending details. In an embodiment, as shown in FIG. 1A, display panticle 3056 may include facilitating the display of one or more of the account information, spending verification information, account balance, location of funds, goods purchased, allocation of funds, and fees associated with the account.

Referring now to FIG. 1-B, in an embodiment, there may be an external tracking application and or/server 3100 (hereinafter interchangeably referred to as the “Daybreak App,” with or without the designation 3100). Daybreak app 3100 is listed in this application as an application and/or server to indicate that in various embodiments, the daybreak app 3100 could be one or more applications, servers, local devices, or a combination thereof. In an embodiment, the daybreak app 3100 is a web extension or a web page. In an embodiment, daybreak app 3100 includes a server portion 3110 and an application portion 3105. In an embodiment, application portion 3105 may be distributed to various devices and/or servers under the control of one or more of philanthropist/user 3005, charity organization 3015, local bank 3200, and national domestic bank 3300.

Referring again to FIG. 1-B, in an embodiment, panticle 3120 represents a creation of an internal account for the computationally-attributable account. The internal account may track payments of money to various entities throughout the life cycle. In an embodiment, the internal account tracks money that is transferred between midpoint entities (e.g., not the direct providers of services, but subcontractors, middle men, governments, etc., as will be described in more detail herein), but does not actually take steps to move the money until it reaches its ultimate destination.

In an embodiment, the internal account may follow an account rule set, shown in more detail in FIG. 1-C. FIG. 1-C shows some of the rule set circuitry for implementing various rules and conditions, which will be discussed in more detail herein.

Referring back to FIG. 1-B, in an embodiment, in accordance with the creation of the internal account, with an initial balance of, for example, one million (1,000,000) dollars (the actual number is exemplary only and does not matter), the money will be transferred from the charitable organization 3015 and/or the philanthropist/user 3005 to a banking entity. In an embodiment, this transfer may be accomplished by an ACH transfer from an account under the control of one or more of the charitable organization 3015 and/or the philanthropist/user 3005 to a bank which has a relationship with the external tracking app. Panticle 3130 represents the facilitation of a transfer of funds to a local bank 3200 or a national bank 3300, although other banks represented throughout FIG. 1, and other financial institutions generally, may be represented.

Referring now to FIG. 1-C, FIG. 1-C shows external tracking architecture 3100 (which will hereinafter be interchangeably referred to as “Daybreak architecture 3100”). The term “Daybreak” here is merely an identifier and does not have any specific functional meaning. In an embodiment, the Daybreak architecture 3100 may be separate from the other entities in FIG. 1, e.g., the banks, the users, the organizations, and the endpoint goods and/or services providers. For example, in an embodiment, Daybreak architecture may run on a separate server, and may interface with various banking and other entities through various interfaces, e.g., an XML template interface (e.g., as will be described in more detail with respect to panticle 3160). In an embodiment, Daybreak architecture 3100 may run on a server 3110, as shown in FIG. 1-B, and may be associated with one or more banking entities, e.g., national domestic bank 3300. In an embodiment, Daybreak architecture 3100 may have a single account with a banking entity, e.g., national domestic bank 3300, in which all of the various funds contributed from various users 3005 are deposited. The funds in these accounts may be managed by the Daybreak architecture through use of various ledger transactions, e.g., paper transactions that represent tracking money as it moves through various entities, but in which the money itself is not transferred. For example, in an embodiment, Daybreak architecture 3100 may effect actual transfers only when money is deposited from an outside source, and when money is “offboarded,” that is transferred to an entity such that it has complied with the distribution rule sets, and is no longer under the control and/or supervision of the Daybreak architecture 3100.

In another embodiment, Daybreak architecture may be separate from the other entities shown in FIG. 1, but may use a multitude of accounts, which may be across various banks, and which may, or in other embodiments, may not, have a correlation to the accounts 3030 that are created by the users 3005 and/or the organizations 3015 that have deposited the funds. In an embodiment, for example, Daybreak architecture 3100 may create a separate account each time money is transferred from one or more users 3005 and/or organizations 3015. In another embodiment, for example, money transferred under the control of Daybreak architecture 3100 may be grouped by how it is to be spent (e.g., different accounts for various services) or where it is to be spent (e.g., different accounts for different known endpoints).

In another embodiment, Daybreak architecture 3100 may be integrated into any one or more of the entities shown in FIG. 1, and which will be discussed in more detail herein. For example, in an embodiment, although not pictured for ease in understanding, Daybreak architecture 3100 may be implemented by national domestic bank 3300, and in an embodiment, other entities that wish to access the Daybreak architecture 3100 may work with national domestic bank 3300. The same applies to any other of the entities shown in FIG. 1, including the user 3005 and the organization 3015. For example, in an embodiment, Daybreak architecture 3100 may be implemented by the organization 3015 as a way to track and/or manage its funds and their allocation.

In an embodiment, the Daybreak architecture 3100 may include an interface that is accessible to any of the entities shown in FIG. 1, including user 3005 and/or organization 3015. In an embodiment, e.g., as shown in FIG. 1-B, this interface may be app 3015, which may run on the Internet, on other devices, on mobile phones, tablets, “smart” devices, and other similar electronics. In an embodiment, various entities in FIG. 1 may have access to various levels of data regarding the flow of funds from account 3030. For example, in an embodiment, the user 3005/organization 3015 may have complete access to all entities that are participating in their particular account set up by Daybreak architecture 3100. In another embodiment, each entity may have access only to its own portion of the funds. In another embodiment, each entity may have downstream visibility for its funds (e.g., each entity can see the ledger transactions that occur after it receives funds from a ledger transaction, but not what happens before). In an embodiment, the distribution rule set may specify the level of access for each of the entities that has access to the Daybreak architecture 3100.

Referring again to FIG. 1-B, in an embodiment, Daybreak architecture 3100 may include panticle 3120, which may implement the creation of an internal account. For example, in an embodiment, the donation 3020 (shown in FIG. 1-A) to the local bank 3200 (shown in FIG. 1-E) may trigger the creation of an internal account in the daybreak architecture 3100 at panticle 3120 (referring back to FIG. 1-B). In an embodiment, there may be a rule set associated with that account (or portions of that account), which will be discussed in more detail herein with respect to FIG. 1-C. In an embodiment, the account rule set may be specified by user 3005, organization 3015, Daybreak architecture 3100 (e.g., which may have a default rule set, or a rule set based on previous rule sets used by user 3005/organization 3015), some other entity shown in FIG. 1, or some other combination thereof. In an embodiment, the internal account created at panticle 3120 may be accessed by any or all of the entities shown in FIG. 1.

Referring again to FIG. 1-B, in an embodiment, the creation of (or addition to) internal account by the Daybreak architecture 3100 may trigger a facilitation of the transfer of funds from the user 3005/organization 3015 to a bank, e.g., local bank 3200 or national bank 3300, e.g., as shown in panticle 3130. As will be discussed in more detail herein, in an embodiment, funds may be transferred from user 3005/organization 3015 to a bank account under the at least partial control of the Daybreak architecture 3100. This transfer may be accomplished through traditional means, e.g., ACH transfer, wire transfer, etc. In an embodiment, further moves of the funds may be handled internally, e.g., through what will be referred to throughout this application as “ledger transactions,” that is, the money does not move from the account in which it was initially deposited, but transfers of the money are displayed and treated as if the money had actually been moved through the Daybreak architecture. For example, in an embodiment, user 3005 may contribute three thousand (3,000) dollars to be used in the system of FIG. 1. In an embodiment, the Daybreak architecture 3100 creates an account with three thousand (3,000) dollars in it. In an embodiment, that three thousand dollars is deposited in the existing bank account under the control of the Daybreak architecture 3100. In an embodiment, further transactions that are not to the endpoint service providers (e.g., transfers to subcontractors, to middle men, to other banks, etc.), are recorded as ledger transactions, e.g., as shown in panticle 3140, but may not include actual transfers of the money.

For example, in an embodiment, the Daybreak architecture may store, as an example from the previous paragraph, the three thousand (3,000) dollars in an account with local bank 3200, and the money is transferred from a bank account of organization 3015 to the Daybreak architecture 3100 account. From there, the money is transferred to national bank 3200. In an embodiment, as implemented by panticle 3140, this may be a “ledger transaction” in which the money is recorded as transferred to national bank 3300, and national bank 3300 has control of the money (within the Daybreak architecture 3100), but the money is not actually transferred from local bank 3200 to national bank 3300. Rather, each of the intermediary transactions between the final payee and the account under the control of the Daybreak architecture are executed as ledger transactions.

In an embodiment, when the funds reach an endpoint services provider, e.g., FO/NGO/FI 3800 (which will be discussed in more detail herein), this payee may receive the funds directly. At this point, another ledger transaction may be executed from wherever the funds are at the time (e.g., at NU/NE bank 3500) according to the ledger transactions, to the FO/NGO/FI 3800, who is the receiver of the funds. At this point, the ledger transaction may also be implemented, e.g., at panticle 3150, as an offboarding of the money, e.g., the actual funds are transmitted from the account with local bank 3200 to the FO/NGO/FI 3800, in addition to the ledger transaction. This may be accomplished, for example, in a specific implementation, by panticle 3160, which is the implementation of an XML, interface that is sent to local bank 3200.

In an embodiment, the controllers of external tracking architecture 3100 may have a relationship with one or more specific banks at the local or national level. In an embodiment, external tracking architecture 3100 may be embedded into local domestic bank 3200 or national domestic bank 3300, and may have one or more components interacting with the various components.

Referring now to FIG. 1-C, in an embodiment, the Daybreak architecture 3100 may implement a rule set related to the account and the funds therein. Panticle 4900 shows a variety of exemplary rules that may be applied to the funds, some of which will be additionally listed and/or elaborated upon here. This list of rules that could be part of the rule set is not intended to be exhaustive or limiting, but rather exemplary.

For example, in an embodiment, rule set 4900 may include metadata that is linked to the account. For example, as the funds are transferred through the ledger transactions, metadata that identifies one or more properties of user 3005 (e.g., who may be a philanthropist, as a specific example). The metadata may identify to whom the money belongs, for example, or any other data that may “travel” with the money. In an embodiment, this may include some form of modified digital currency, e.g., a Bitcoin-like setup, which may be localized or specified for specific accounts.

Referring again to FIG. 1-C, in an embodiment, rule set circuitry panticle 3900 may include geographic location tracking of goods and/or services that are associated with the account or distributed with the account. For example, in an embodiment, a rule set may specify that certain funds may only be spent at particular geographic locations. For example, the rule set may specify that the money must be spent in specific locations in Sub-Saharan Africa. In another embodiment, the rule set may specify that the money must be spent in locations associated with hospitals, or schools. The rule set may depend on conditions, as well. For example, in an embodiment, the rule set may specify that the money may only be spent in locations that have an average GDP per capita below a certain amount. In an embodiment, the location tracking may include GPS verification (e.g., when the money is transferred to an entity, that entity's location is recorded), or verification of location through monitoring of satellite pictures, pictures taken onsite, geotagged images, or trusted person/device verification.

Referring again to FIG. 1-C, in an embodiment, rule set circuitry panticle 3900 may include an account fee tracking function, e.g., which, in an embodiment, may set limits and/or conditions on how much account fees can be charged by the various banking entities. In an embodiment, the amounts and conditions may be changed if the Daybreak architecture 3100 is used versus the money being transferred between one or more of the various midpoints. Moreover, in an embodiment, each amount and/or condition may be different depending on the conditions at the midpoint entity. In an embodiment, the amount limits and/or conditions may be dependent upon conditions themselves, e.g., “if X happens, then an escalating limit may be established.” In an embodiment, the amount of funds stored/controlled/ledger transferred to the various banks and/or entitites may control the limits and/or conditions on the account fees. In another embodiment, the rule set may specifiy changes to the limits and/or conditions when a number of transactions (e.g., true transactions or ledger transactions) are carried out.

Referring again to FIG. 1-C, in an embodiment, rule set circuitry panticle 3900 may include a rule set that specifies a requirement for photographic evidence associated with the acquisition/distribution of goods/services. For example, in an embodiment, the rule set may specify that, at the point of delivery of goods and/or services, photo documentation must be captured at the time of the transaction for the money to be released (e.g., it may be ledger transacted in the Daybreak architecture 3100, but with separate requirements for an actual transfer of the funds). Referring again to FIG. 1-C, in an embodiment, rule set circuitry panticle 3900 may include implementation of a spending limit associated with the goods and/or services, e.g., as will be discussed in more detail herein. In an embodiment, rule set circuitry panticle 3900 may include implementation of a spending linked to the nature of the goods/and or services (e.g., funds are restricted to particular classes of goods, e.g., vaccines, food, clothing, etc.).

Referring again to FIG. 1-C, in an embodiment, rule set circuitry panticle 3900 may include implementation of a time stamp for receipt of distribution of funds asscociated with the delivery of goods and/or services. For example, this time stamp may take the form of a time-tagged photo, a time-tagged post to the internet (e.g., through any medium, via twitter, e-mail, etc.), location (e.g., GPS) confirmation of the location and/or meeting of the parties. In an embodiment, rule set circuitry panticle 3900 may include implementation of a system in which payment is given (e.g., which may be the “ledger transaction” payment or the “actual transfer of funds” payment, depending on embodiments). In an embodiment, rule set circuitry panticle 3900 may include implementation of a trusted sources system, in which the payment for goods and/or services must be verified by a trusted source, either by previous dealings, outside reputation score, or some other trust-verification system. In an embodiment, Daybreak architecture 3100 may implement a trust level system for individuals and/or organizations. In another embodiment, Daybreak architecture may tap into one or more existing systems.

Referring again to FIG. 1-C, in an embodiment, rule set circuitry panticle 3900 may include implementation of a limit of funding available to sources based on past history, and a term sheet for specific endpoint entities. In an embodiment, rule set circuitry panticle 3900 may include implementation of a a system for recouping funds (e.g., forcing return of funds if the agreement for the acquisition and/or the distribution is not met). For example, in an embodiment, the ledger transaction that transfers the money may be allowed to go through prior to the actual transfer of funds, and if the conditions specified in the rule set are not met, the actual transfer of funds may be stopped and/or delayed (e.g., in an embodiment, this may use delays in timing of banking processes in order to implement).

Referring again to FIG. 1C, in an embodiment, rule set circuitry panticle 3900 may include implementation of a reputation system for actors, either through Daybreak architecture 3100, through tapping an existing system, and/or through analysis of social media, an encryption function, e.g., through a multi-part encryption key to be sent through at least two different transmission routes, a currency conversion function (e.g., exchange rate determinations, a currency transfer unit, digital currency protections, and language conversion function.

Referring again to FIG. 1-C, in an embodiment, rule set circuitry panticle 3900 may include implementation of scoring engine that analyzes vendors, transactions, etc., and compares to programmed patterns. For example, in an embodiment, a scoring engine may analyze a transaction and drop it into one of three buckets. Bucket 1 is “definitely bad,” bucket 2 is “definitely good,” and bucket 3 is “needs human evaluation for final decision” so the scoring engine will drop it into one of those three buckets.

Referring now to FIG. 1-E, FIG. 1-E shows Box 12, which starts at FIG. 1-E, and extends through FIGS. 1-F and 1-G, describes that, in an embodiment, actual monetary transfers (e.g., ACH transfers, wire transfers, and the like) may be used at endpoints of various transactions between the philanthropist/user's 3005 bank account, e.g., at local bank 3200, and the foreign organization/NGO/foreign individual 3800 (e.g., as shorthand, “foreign organization/NGO/Foreign Individual 3800” will hereafter be interchangeably referred to as “foreign entity 3800”). That is, in an embodiment, endpoint money transfers may be made at local bank 3200 (or one of the other entity banks), and may be made at the foreign entity 3800, with other transactions occurring as “ledger transactions.” In an embodiment, this may except offboarding of funds designated for a specific entity.

For example, in an embodiment, donation 3020 may be given by the philanthropist/user 3005 (e.g., through the charity organization 3015). Donation 3020 may be received by local bank 3200. In an embodiment, local bank 3200 may create an account for the charity funds 3220, e.g., “Fund X” (hereinafter will be interchangeably referred to as “account 3220”). In an embodiment, Fund X may be the repository for the funds until they are paid out to a specific person, e.g., foreign entity 3800, or appropriated as part of a fee by an intervening entity, e.g., offboarded, e.g., as shown in panticles 3350, 3450, and 3550, which will be discussed in more detail herein. In an embodiment, any movement of funds between other entities, e.g., entities inside the box 12, may occur as ledger transactions. In another embodiment, funds may be moved from the local bank 3200 (e.g., Omaha bank) to other banking/management entities as will be described herein.

Referring again to FIG. 1-E, in an embodiment, local bank 3200 may use an existing account 3230, and earmark the charity funds for specific distributions according to their rule set. For example, in an embodiment, local bank 3200 may have a single account that uses the daybreak architecture, which may be implemented as external tracking architecture 3100 (e.g., see FIG. 1-B, which will be discussed in more detail herein), or by a system similar to external tracking architecture 3100 but implemented partially or wholly internal to local bank 3200. In an embodiment, any funds that will be managed by the daybreak architecture 3100 will be placed in the existing account 3230, and can be tracked through ledger transactions and payouts to end recipients of funds, as will be discussed in more detail herein.

Referring again to FIG. 1-E, in some embodiments, whether account 3220 or 3230 is used, panticle 3210 includes panticle 3212 of creation of a unique and/or anonymous identifier and password. In an embodiment, this identifier/password 3212 may be login information that will be given to user 3005 in order to access the account, change the rule set, and receive reports and/or auditing regarding the account 3220 or 3230. In an embodiment, at panticle 3214, data may be sent to the user 3005. This data may include one or more tools used to access the information, e.g., login credentials for a network application, in an embodiment, or a mobile application for interfacing with bank 3200 and/or daybreak architecture 3100.

Referring again to FIG. 1-E, FIG. 1-E shows a national domestic bank 3300 (e.g., hereinafter interchangeably referred to as “national bank 3300”). In an embodiment, national domestic bank 3300 may be a nationally-established bank, e.g., Bank of New York. In an embodiment, national bank 3300 may receive a request at panticle 3302, e.g., a request from the local bank 3200 (e.g., Omaha bank), which is a request for the bank to accept the tracking and/or verifying account. In an embodiment, panticle 3302 may include the request from local bank 3200 for national bank 3300 to register an account with the Daybreak architecture 3100 (e.g., which, as previously described, may be separate from one or more of the figures in this entity, or may be partially or wholly integrated with one or more of the entities in this figure).

Referring again to FIG. 1-E, in an embodiment, national bank 3300 may, at panticle 3304, send a confirmation that the national bank 3300 will accept the tracking and verification account. In an embodiment, panticle 3304 may include the notification of acceptance and/or completion of registration with the Daybreak architecture 3100. In an embodiment, registration may mean that the national bank 3300 is newly registered with the Daybreak architecture 3100, or that the national bank 3300 is adding data to the registration indicating its acceptance of the account created in panticle 3210. In an embodiment, at panticle 3304, national bank 3300 may communicate with Daybreak architecture 3100 (not shown in panticle 3304).

Referring again to FIG. 1-E, in an embodiment, national bank 3300 may, at panticle 3306, receive a donation sent from the local bank 3200. In an embodiment, panticle 3306 may represent national bank 3300 receiving an actual transfer of funds into its accounts, e.g., via an ACH or a wire transfer. In another embodiment, panticle 3306 may represent a ledger transfer of the funds, as represented in Daybreak architecture 3100, but the location of the funds stays in an account with local bank 3200, e.g., in the Daybreak architecture.

In an embodiment, as described above, a ledger transaction may show a funds transfer to national bank 3300 as performed by the Daybreak architecture 3100, but the actual funds may stay in the account designated by the daybreak architecture 3100 at local bank 3200. Nevertheless, national bank 3300 may be authorized to draw funds from the account for services rendered, e.g., national bank 3300 may be awarded a flat fee of five thousand (5,000) dollars or a percentage of the contents of the account created/used by local bank 3200. In such an embodiment, the national bank's 3300 funds to which they are entitled are “offboarded” at panticle 3350 of FIG. 1-A. In this context, offboarded means that the funds to which national bank 3300 is entitled, which are part of the overall funds which have been ledger-transferred to national bank 3300 but are still in possession of an account at local bank 3200, said funds are actually transferred to the national bank 3300 through conventional means, e.g., an ACH transfer or a wire transfer. Thus, if the account contains one million (1,000,000) dollars that have been ledger transferred from local bank 3200 to national bank 3300, and the national bank 3300 is collecting a five thousand (5,000) dollar payment for services rendered, then in addition to the ledger transaction that transfers the one million (1,000,000) dollars from local bank 3200 to national bank 3300, another ledger transaction is made from the ledger account at national bank 3300 that contains the one million (1,000,000) dollars, into a personal account under the control of national bank 3300. This ledger transaction is for the five thousand (5,000) dollars and is accompanied by an actual transfer (e.g., wire transfer or ACH transfer) of five thousand (5,000) dollars. Once the money has been subject to an actual transfer, tracking and/or verification may be stopped, as the money is now in the possession/control of national bank 3300. It is noted that the Daybreak architecture 3100 makes sure that any actual transfer out of the account under control of local bank 3200 must meet the rule set conditions specified, which will be discussed in more detail herein.

Referring now to FIG. 1-F, FIG. 1-F shows a European bank 3400, e.g., the Bank of England, according to various embodiments. Although bank 3400 is labeled “European bank,” bank 3400 is not limited to being located in Europe. Bank 3400 may be any bank external to the United States, regardless of location, that participates in the management and/or distribution of funds from the account 3030 (and/or other accounts that may be established throughout FIG. 1). In an embodiment, at panticle 3402, the national bank 3300 may send the request to European bank 3400 to accept and implement the tracking and/or verifying account. In an embodiment, panticle 3402 may include the request (e.g., from local bank 3200, although the request could come from any entity shown in FIG. 1) for national bank 3400 to register an account with the Daybreak architecture 3100 (e.g., which, as previously described, may be separate from one or more of the figures in this entity, or may be partially or wholly integrated with one or more of the entities in this figure).

Referring again to FIG. 1-F, FIG. 1-F shows European bank with panticle 3404. Panticle 3404 describes European bank 3400 sending a confirmation that European bank 3400 will accept and implement the tracking and/or verification account. In an embodiment, this acceptance may include opening a new account and accepting a monetary transfer (e.g., through wire transfer, ACH, or other means) of the account funds, and managing an account similar to account 3030. In an embodiment, panticle 3404 may include the notification of acceptance and/or completion of registration with the Daybreak architecture 3100. In an embodiment, registration may mean that the European bank 3400 is newly registered with the Daybreak architecture 3100, or that the European bank 3400 is adding data to the registration indicating its acceptance of the account created in panticle 3210. In an embodiment, at panticle 3304, European bank 3400 may communicate with Daybreak architecture 3100 (not shown in panticle 3404).

Referring again to FIG. 1-F, in an embodiment, European bank 3400 may operate with panticle 3406. In an embodiment, panticle 3406 may represent a receiving of a donation sent from the national bank 3300, or, in another embodiment from one or more of the other entities shown in FIG. 1.. In an embodiment, panticle 3406 may represent European bank 3400 receiving an actual transfer of funds into its accounts, e.g., via an ACH or a wire transfer. In another embodiment, panticle 3406 may represent a ledger transfer of the funds, as represented in Daybreak architecture 3100, but the location of the funds stays in an account with local bank 3200, e.g., in the Daybreak architecture.

Referring again to FIG. 1-F, in an embodiment, at panticle 3408, the European bank 3400 may conduct an audit of the funds that have been spent and/or distributed for a given time. The audit may include all of the downstream and/or upstream activity from the European bank 3400. In an embodiment, the audit may be conducted through analysis of the ledger transactions executed by the Daybreak architecture 3100. Audit details will be described in more detail further herein.

In an embodiment, as described above, a ledger transaction may show a funds transfer to European bank 3400 as performed by the Daybreak architecture 3100, but the actual funds may stay in the account designated by the daybreak architecture 3100 at local bank 3200. Nevertheless, European bank 3400 may be authorized to draw funds from the account for services rendered, e.g., European bank 3400 may be awarded a flat fee of five thousand (5,000) dollars or a percentage of the contents of the account created/used by local bank 3200. In such an embodiment, the funds to which European bank 3400 is entitled are “offboarded” at panticle 3350 of FIG. 1-A. In this context, offboarded means that the funds to which European bank 3400 is entitled, which are part of the overall funds which have been ledger-transferred to European bank 3400 but are still in possession of an account at local bank 3200, said funds are actually transferred to the European bank 3400 through conventional means, e.g., an ACH transfer or a wire transfer. Thus, if the account contains one million (1,000,000) dollars that have been ledger transferred from local bank 3200 to European bank 3400, and the European bank 3400 is collecting a five thousand (5,000) dollar payment for services rendered, then in addition to the ledger transaction that transfers the one million (1,000,000) dollars from local bank 3200 to European bank 3400, another ledger transaction is made from the ledger account at European bank 3400 that contains the one million (1,000,000) dollars, into a personal account under the control of European bank 3400. This ledger transaction is for the five thousand (5,000) dollars and is accompanied by an actual transfer (e.g., wire transfer or ACH transfer) of five thousand (5,000) dollars. Once the money has been subject to an actual transfer, tracking and/or verification may be stopped, as the money is now in the possession/control of European bank 3400. It is noted that the Daybreak architecture 3100 makes sure that any actual transfer out of the account under control of local bank 3200 must meet the rule set conditions specified, which will be discussed in more detail herein.

Referring now to FIG. 1-J (to the south of FIG. 1-F), in an embodiment, European bank 3400 may implement a panticle 3200, which may facilitate the reputation/trustworthiness verification as part of the chain. It is noted that, although these panticles are associated with European bank 3400, this is merely for ease of display, and any of the entities shown in FIG. 1 may implement similar methods and/or systems. For example, in an embodiment, panticle 3200 may include panticle 3210, in which the European bank 3400 verifies the reputation and/or trustworthiness of one or more of the other entities shown in FIG. 1. In an embodiment, this is because European bank 3400 has a higher trust score, e.g., has a trust score that makes it a verified source according to the rule set architecture put in place for a specific account by the Daybreak architecture 3100. In an embodiment, panticle 3210 may implement verification using one or more of reputation score 4212 and/or past accounting and/or reporting history.

Referring again to FIG. 1-J, in an embodiment, at panticle 3220, the verification of the reputation and/or trustworthiness of other entities may include acquisition, analysis, implementation, or other actions taken toward the rule set, if such are not implemented by Daybreak architecture 3100. For example, in an embodiment, European bank 3400 may include panticle 3230 in which European bank 3400, alone or in conjunction with Daybreak architecture 3100, may facilitate one or more actions that go with implementing a rule set for the acquisition and/or distribution of funds, to one or more of subcontracting foreign organizations (e.g., subcontracting foreign organization 3700) and Foreign Organization/Non-Governmental Organization/Foreign Individual (FO/NGO/FI), e.g., FO/NGO/FI 3800. The rule set architecture will be described in more detail with respect to panticle 3900 of FIG. 1-C. In an embodiment, European bank panticle 3230 may receive the rule set from Daybreak architecture 3100. In an embodiment, the funds from the account 3030 may not be actually transmitted to European bank panticle 3230, but may be transmitted through ledger transactions. In another embodiment, European bank panticle 3230 may implement the rule set from Daybreak architecture 3100 for the funds from the account 3030 that are actually received by European bank 3400.

In an embodiment, referring again to European bank panticle 3230 of FIG. 1-J, European bank panticle 3230 may include panticle 3232, in which panticle 3232 effects an implementation of an acquisition or a distribution of funds rule set based on a type of goods and/or services (e.g., food, water, potable water, medicine, vaccines, health care services, shelters, clothing, tools, transport services, vehicles, firearms, etc.). For example, a part of the distribution rule set may specify that the funds must be spent on vaccinations or organizations that provide vaccinations. In another example, a part of the distribution rule set may specify that certain types of drugs cannot be purchased with funds from the account 3030, e.g., prohibition on Schedule 2 narcotics, for example.

In an embodiment, referring again to European bank panticle 3230 of FIG. 1-J, European bank panticle 3230 may include panticle 3234, in which panticle 3234 effects an implementation of an acquisition or a distribution of funds rule set based on a distribution area of goods and/or services (e.g., food, water, potable water, medicine, vaccines, health care services, shelters, clothing, tools, transport services, vehicles, firearms, etc.). In an embodiment, the distribution area may be purely geographical (e.g., “between the two rivers,” or “within a box defined by specific latitudes and longitudes), political (e.g., within the boundaries of a specific foreign country), or data-based (e.g., “only to areas in which the poverty rate is above 85%,” or “only to areas in which HIV infection is above 22%”). For example, a part of the distribution rule set may specify that the funds can only be spent in targeted areas of sub-Saharan Africa.

In an embodiment, referring again to European bank panticle 3230 of FIG. 1-J, European bank panticle 3230 may include panticle 3236, in which panticle 3236 effects an implementation of an acquisition or a distribution of funds rule set based on a quantity of goods and/or services (e.g., food, water, potable water, medicine, vaccines, health care services, shelters, clothing, tools, transport services, vehicles, firearms, etc.) to be provided. The numbers may be absolute, e.g., “this money must be used to purchase three thousand (3,000) vaccines,”) or relative (e.g., “30% of this money must be used to purchase vaccines).

Referring again to FIG. 1-J, in an embodiment, European bank 3400 may, in a process of implementing reputation and/or trustworthiness verification, e.g., at panticle 4200, implement a reporting rule set for various downstream entities to report distribution of funds. For example, panticle 3250 may include facilitating implementation of the reporting rule set (which may be similar to the acquisition/distribution rule set, and which may be developed/implemented in conjunction with Daybreak architecture 3100). In an embodiment, implementation of the reporting rule set for one or more entities may include requiring an audit of the various entities upon request, e.g., as described in panticle 3255.

Referrign again to FIG. 1-J, in an embodiment, European bank 3400 may, in a process of implementing the reporting rule set, at panticle 3260, reporting evidence of the transaction may be required. The reporting evidence may be required as a condition of releasing the funds, which, in an embodiment, may be preventing the ledger transaction of the funds, or preventing an actual underlying transaction of the funds to the endpoint entity. For example, in an embodiment, the panticle 3260 that requires reporting evidence may require, e.g., photographic evidence, as part of panticle 3262. Photographic evidence here may include audio, video, still shot, any capture of light and/or motion in any portion of the electromagnetic spectrum, and also may include metadata, e.g., timestamp of photo and/or geolocation tagging of photo (e.g., from a camera device with geolocation/timestamp tagging enabled).

Referring again to FIG. 1-J, in an embodiment, European bank 3400 may implement reporting rule set at panticle 3250, which may include panticle 3260 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 3260 may include panticle 3264, which may implement a reporting rule set through use of various monitoring devices, which may be attached to various goods, e.g., food goods, shipping containers, vaccines, clothing, etc.) The monitoring devices may use near-field communication, or may be RFID tags. In an embodiment, the monitoring may be accomplished through surveillance, e.g., visual, infrared, or some other form, from localized cameras or satellite cameras, for example.

Referring again to FIG. 1-J, in an embodiment, European bank 3400 may implement reporting rule set at panticle 3250, which may include panticle 3260 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 3260 may include panticle 3266, which includes verification from a trusted source as a requirement for reporting. For example, in an embodiment, if an unknown/untrusted FO/NGO/FI 3800, which may be an endpoint entity, performs a service, and wants to receive compensation, they may seek verification from a trusted source, e.g., which may be a different FO/NGO/FI 3800, or some other entity, which may or may not be associated with the Daybreak architecture 3100. In an embodiment, Daybreak architecture 3100 may keep the list of trusted sources and require verification from those sources, however, in another embodiment, the trusted sources may become trusted sources through a relationship with European bank 3400 or one of the other banking entities.

Referring again to FIG. 1-J, in an embodiment, European bank 3400 may implement reporting rule set at panticle 3250, which may include panticle 3260 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 3260 may include panticle 3268 and/or panticle 3269, which may require real time reporting associated with implementation of the goods and/or services, or real time reporting associated with payment for the implementation of the goods and/or services.

In an embodiment, Daybreak architecture 3100, and in conjunction with one or more of the other entities shown in FIG. 1, or independently, may build out at least two different types of rule sets. The first will be to prevent known fraud schemes, e.g., such as use of a phantom vendor, no-bid arrangements, bad acting vendors, imaginary vendors, and the like. A second type of rule set, in an embodiment, may be a set of attributes, e.g., characteristics that alone do not mean anything, but may in certain circumstances or in combination with other attributes, may raise flags that require further analysis or may require delaying the transaction until clearance. For example, in an embodiment of the attribute set, odd time of day, transactions on holidays, transactions late at night, or structured transactions, transactions that are right at the approval limit, may, in some various combinations, require additional approval or other steps to be taken to release the funds from the Daybreak architecture 3100 or the other entities shown in FIG. 1.

Referring again to FIG. 1-F, FIG. 1-F shows non-USA/non-European bank (e.g., shown in FIG. 1 as “Central Bank of Kenya,” but this is just an example) 3500 (hereinafter interchangeably referred to as NU/NE “bank 3500”). NU/NE bank 3500 may communicate with one or more of the entities shown in FIG. 1. In FIG. 1, NU/NE bank 3500 is shown in communication with European bank 3400, but in other embodiments, NU/NE bank 3500 may communicate with other entities depicted in FIG. 1, regardless of whether lines are directly drawn that connect NU/NE bank 3500 to those entities (the same is also true for the other banks discussed previously and discussed herein).

Referring again to FIG. 1-F, in an embodiment, the European bank 3400 may send the request for NU/NE bank 3500 to accept and/or implement the tracking and/or verifying account at panticle 3502. In an embodiment, e.g., as shown in FIG. 1-F, this request comes from European bank 3400, but, in other embodiments, the request may come from any other entity depicted in FIG. 1. In an embodiment, at panticle 3502, the European bank 3400 may send the request to NU/NE bank 3500 to accept and implement the tracking and/or verifying account. In an embodiment, panticle 3502 may include the request (e.g., from local bank 3200, although the request could come from any entity shown in FIG. 1) for NU/NE bank 3500 to register an account with the Daybreak architecture 3100 (e.g., which, as previously described, may be separate from one or more of the figures in this entity, or may be partially or wholly integrated with one or more of the entities in this figure).

Referring again to FIG. 1-F, in an embodiment, NU/NE bank 3500 may include panticle 3504. Panticle 3504 describes NU/NE bank 3500 sending a confirmation that indicates acceptance and/or implementation of a tracking and or verification account. This confirmation may be sent electronically or may be part of a general agreement that governs particular types of accounts or transactions, or may be implemented in a different way. In an embodiment, this acceptance may include opening a new account and accepting a monetary transfer (e.g., through wire transfer, ACH, or other means) of the account funds, and managing an account similar to account 3030. In an embodiment, panticle 3504 may include the notification of acceptance and/or completion of registration with the Daybreak architecture 3100. In an embodiment, registration may mean that the NU/NE bank 3500 is newly registered with the Daybreak architecture 3100, or that the NU/NE bank 3500 is adding data to the registration indicating its acceptance of the account created in panticle 3210. In an embodiment, at panticle 3504, NU/NE bank 3500 may communicate with Daybreak architecture 3100 (not shown in panticle 3404).

Referring again to FIG. 1-F, in an embodiment, NU/NE bank 3500 may implement panticle 3506. In an embodiment, panticle 3506 may represent reception of account funds (e.g., the donation) from European bank 3400, or, in another embodiment from one or more of the other entities shown in FIG. 1. In an embodiment, panticle 3506 may represent a ledger transfer of the funds, as represented in Daybreak architecture 3100, but the location of the funds stays in an account with local bank 3200, e.g., in the Daybreak architecture.

Referring again to FIG. 1-F, in an embodiment, at panticle 3508, NU/NE bank 3500 may conduct an audit of the funds that have been spent and/or distributed for a given time. The audit may include all of the downstream and/or upstream activity from NU/NE bank 3500. In an embodiment, the audit may be conducted through analysis of the ledger transactions executed by the Daybreak architecture 3100. Audit details will be described in more detail further herein.

Referring now to FIG. 1-K, in an embodiment, the reporting rule set may be implemented by NU/NE bank 3500, although, in other embodiments, any of the entities in FIG. 1 may implement the reporting rule set, alone or in conjunction with the Daybreak architecture 3100, or singly by the Daybreak architecture 3100. In an embodiment, NU/NE bank 3500 may include panticle 3300, which may include implementation of the reporting rule set.

In an embodiment, panticle 3300 may include panticle 3310, in which a request for an audit of the account, e.g., whether the account has followed the rule set implemented by the various entities of FIG. 1, either as a whole-picture audit, a single-entity audit, or a downstream-entity audit, or some combination thereof, is made. The audit may take any form as requested by the entity requesting the audit, and may include any data to which the requesting entity has access. In an embodiment, the audit may be performed by Daybreak architecture 3100, and facilitated or passed along by NU/NE bank 3500. In another embodiment, Daybreak architecture 3100 may assist NU/NE bank 3500 in performing the audit, and, in another embodiment, NU/NE bank 3500 may perform the audit without the assistance of Daybreak architecture 3100.

Referring again to FIG. 1-K, in an embodiment, implementation of reporting rule set panticle 3300 may include a reporting evidence requirement panticle 3350. Panticle 4350 may implement architecture in which reporting evidence of the transaction may be required. The reporting evidence may be required as a condition of releasing the funds, which, in an embodiment, may be preventing the ledger transaction of the funds, or preventing an actual underlying transaction of the funds to the endpoint entity. For example, in an embodiment, the panticle 3350 that requires reporting evidence may require, e.g., photographic evidence, as part of panticle 3352. Photographic evidence here may include audio, video, still shot, any capture of light and/or motion in any portion of the electromagnetic spectrum, and also may include metadata, e.g., timestamp of photo and/or geolocation tagging of photo (e.g., from a camera device with geolocation/timestamp tagging enabled).

Referring again to FIG. 1-K, in an embodiment, NU/NE bank 3500 may implement reporting rule set at panticle 3300, which may include panticle 3350 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 3350 may include panticle 3354, which may implement a reporting rule set through use of various monitoring devices, which may be attached to various goods, e.g., food goods, shipping containers, vaccines, clothing, etc.) The monitoring devices may use near-field communication, or may be RFID tags. In an embodiment, the monitoring may be accomplished through surveillance, e.g., visual, infrared, or some other form, from localized cameras or satellite cameras, for example.

Referring again to FIG. 1-K, in an embodiment, NU/NE bank 3500 may implement reporting rule set at panticle 3300, which may include panticle 3350 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 3350 may include panticle 3356, which includes verification from a trusted source as a requirement for reporting. For example, in an embodiment, if an unknown/untrusted FO/NGO/FI 3800, which may be an endpoint entity, performs a service, and wants to receive compensation, they may seek verification from a trusted source, e.g., which may be a different FO/NGO/FI 3800, or some other entity, which may or may not be associated with the Daybreak architecture 3100. In an embodiment, Daybreak architecture 3100 may keep the list of trusted sources and require verification from those sources, however, in another embodiment, the trusted sources may become trusted sources through a relationship with NU/NE bank 3500 or one of the other banking entities or other entities shown in FIG. 1.

Referring again to FIG. 1-K, in an embodiment, NU/NE bank 3500 may implement reporting rule set at panticle 3300, which may include panticle 3350 requiring reporting evidence associated with the distribution of goods and/or services prior to payment being made of goods and/or services (e.g., or, in an embodiment, prior to approving the goods and/or services to be carried out/sold), as previously discussed. In an embodiment, panticle 3350 may include panticle 3358 and/or panticle 3359, which may require real time reporting associated with implementation of the goods and/or services, or real time reporting associated with payment for the implementation of the goods and/or services.

Referring again to FIG. 1-K, in an embodiment, FO/NGO/FI 3800 may implement a reporting rule set to report back to one or more entities shown in FIG. 1, e.g., in various embodiments, in conjunction with the Daybreak architecture 3100. For example, in an embodiment, FO/NGO/FI 3800 may implement reporting rule set panticle 4400, which includes audit provision panticle 3410 to provide an audit of the account and/or the funds that were spent by FO/NGO/FI 3800 to one or more of the entities shown in FIG. 1. Additionally, in an embodiment, panticle 3400, as implemented by FO/NGO/FI 3800, ay include panticle 3450 for providing the reporting evidence to one or more entities, which has been previously described with respect to receiving that data. For example, in an embodiment, panticle 3450 may include one or more of panticle 3452 for providing photographic evidence of the goods and/or services being delivered and/or provided. For example, photographic evidence here may include audio, video, still shot, any capture of light and/or motion in any portion of the electromagnetic spectrum, and also may include metadata, e.g., timestamp of photo and/or geolocation tagging of photo (e.g., from a camera device with geolocation/timestamp tagging enabled).

For example, in an embodiment, panticle 3450 may include one or more of panticle 3454 for providing the monitoring information related to the goods and/or services (e.g., food goods, shipping containers, vaccines, clothing, etc.). The monitoring devices may use near-field communication, or may be RFID tags. In an embodiment, the monitoring may be accomplished through surveillance, e.g., visual, infrared, or some other form, from localized cameras or satellite cameras, for example, and panticle 3456 for providing verification from a trusted source, e.g., in an embodiment, if an unknown/untrusted FO/NGO/FI 3800, which may be an endpoint entity, performs a service, and wants to receive compensation, they may seek verification from a trusted source, e.g., which may be a different FO/NGO/FI 3800, or some other entity, which may or may not be associated with the Daybreak architecture 3100. In an embodiment, Daybreak architecture 3100 may keep the list of trusted sources and require verification from those sources, however, in another embodiment, the trusted sources may become trusted sources through a relationship with NU/NE bank 3500 or one of the other banking entities or other entities shown in FIG. 1.

Referring again to FIG. 1-K, in an embodiment, panticle 3450 may include one or more of panticle 3458 and/or panticle 3459, which may require real time reporting associated with implementation of the goods and/or services, or real time reporting associated with payment for the implementation of the goods and/or services.

Referring now to FIG. 1-G, FIG. 1-G shows some examples of services performed by one or more of the entities shown in FIG. 1. This list is not meant to be exhaustive or exclusionary, but merely exemplary. For example, in an embodiment, one or more of the entities in FIG. 1 may include a reputation and/or trustworthiness module. This module, described in panticle 3600, may include a panticle 3610 in which the NU/NE bank 3500 (or another entity from FIG. 1; NU/NE bank 3500 is used throughout FIG. 1-G as an example, but any entity from FIG. 1 or other entity may be substituted in various embodiments without changing the overall operation of the system). At panticle 3610, NU/NE bank 3500 may verify the reputation and/or the trustworthiness of the FO/NGO/FI 3800, through one or more methods, including but not limited to, verification data (e.g., pictures, video, documents, trusted account numbers), pre-existing relationship, identity confirmation, or one or more other techniques which will be discussed in more detail herein. For example, panticle 3610 may facilitate verification of reputation through panticle 3612, which tracks a “reputation score” for various FO/NGO/FI entities (e.g., FO/NGO/FI 3800). In another example, panticle 3610 may facilitate verification of various FO/NGO/FI entities through panticle 3614 which tracks or receives from a tracking entity a past accounting and/or a reporting history regarding the various FO/NGO/FI entities (e.g., FO/NGO/FI 3800).

Referring again to FIG. 1-G, FIG. 1-G shows some examples of services performed by one or more of the entities shown in FIG. 1. This list is not meant to be exhaustive or exclusionary, but merely exemplary. For example, in an embodiment, one or more of the entities in FIG. 1 may include an NU/NE rule set panticle 3650. NU/NE rule set panticle 3650 may, alone or in conjunction with Daybreak architecture 3100, facilitate one or more actions that go with implementing a rule set for the acquisition and/or distribution of funds, to one or more of subcontracting foreign organizations (e.g., subcontracting foreign organization 3700) and Foreign Organization/Non-Governmental Organization/Foreign Individual (FO/NGO/FI), e.g., FO/NGO/FI 3800. The rule set architecture will be described in more detail with respect to panticle 3900 of FIG. 1-C. In an embodiment, NU/NE rule set panticle 3650 may receive the rule set from Daybreak architecture 3100. In an embodiment, the funds from the account 3030 may not be actually transmitted to NU/NE rule set panticle 3650, but may be transmitted through ledger transactions. In another embodiment, NU/NE rule set panticle 3650 may implement the rule set from Daybreak architecture 3100 for the funds from the account 3030 that are actually received by NU/NE bank 3500.

In an embodiment, referring again to panticle 3650 of FIG. 1-G, panticle 3650 may include panticle 3652, in which panticle 3652 effects an implementation of an acquisition or a distribution of funds rule set based on a type of goods and/or services (e.g., food, water, potable water, medicine, vaccines, health care services, shelters, clothing, tools, transport services, vehicles, firearms, etc.). For example, a part of the distribution rule set may specify that the funds must be spent on vaccinations or organizations that provide vaccinations. In another example, a part of the distribution rule set may specify that certain types of drugs cannot be purchased with funds from the account 3030, e.g., prohibition on Schedule 2 narcotics, for example.

In an embodiment, referring again to panticle 3650 of FIG. 1-G, panticle 3650 may include panticle 3654, in which panticle 3654 effects an implementation of an acquisition or a distribution of funds rule set based on a distribution area of goods and/or services (e.g., food, water, potable water, medicine, vaccines, health care services, shelters, clothing, tools, transport services, vehicles, firearms, etc.). In an embodiment, the distribution area may be purely geographical (e.g., “between the two rivers,” or “within a box defined by specific latitudes and longitudes), political (e.g., within the boundaries of a specific foreign country), or data-based (e.g., “only to areas in which the poverty rate is above 85%,” or “only to areas in which HIV infection is above 22%”). For example, a part of the distribution rule set may specify that the funds can only be spent in targeted areas of sub-Saharan Africa.

In an embodiment, referring again to panticle 3650 of FIG. 1-G, panticle 3650 may include panticle 3656, in which panticle 3656 effects an implementation of an acquisition or a distribution of funds rule set based on a quantity of goods and/or services (e.g., food, water, potable water, medicine, vaccines, health care services, shelters, clothing, tools, transport services, vehicles, firearms, etc.) to be provided. The numbers may be absolute, e.g., “this money must be used to purchase three thousand (3,000) vaccines,”) or relative (e.g., “30% of this money must be used to purchase vaccines).

Referring again to FIG. 1-G, FIG. 1-G describes a subcontracting foreign organization (SFO) 3700. SFO 3700 may communicate with one or more of the entities shown in FIG. 1. In FIG. 1, SFO 3700 is shown in communication with NU/NE bank 3500, but SFO 3700 may communicate with other entities depicted in FIG. 1, regardless of whether lines are directly drawn that connect SFO 3700 to those entities (the same is also true for the other banks discussed previously and discussed herein). In an embodiment, SFO 3700 may receive funds from the account 3030 to manage and distribute, for example, among other Foreign Organizations, Non-Governmental Organizations, and Foreign Individuals, e.g., FO/NGO/FI 3800. In an embodiment, SFO 3700 may be enrolled in the Daybreak architecture 3100 and may manage ledger transactions to and/or from the various entities shown in FIG. 1.

In an embodiment, SFO 3700 may include implementations of panticle 3710, in which panticle 3710 may implement verification of the reputation and/or the trustworthiness of the FO/NGO/FI 3800, through one or more methods, including but not limited to, verification data (e.g., pictures, video, documents, trusted account numbers), pre-existing relationship, identity confirmation, or one or more other techniques which will be discussed in more detail herein.

Referring again to FIG. 1-G, in an embodiment, SFO 3700 may include implementations of panticle 3720, in which rule set panticle 3720 may, alone or in conjunction with Daybreak architecture 3100, facilitate one or more actions that go with implementing a rule set for the acquisition and/or distribution of funds, to one or more of subcontracting foreign organizations and/or Foreign Organization/Non-Governmental Organization/Foreign Individuals (FO/NGO/FI), e.g., FO/NGO/FI 3800. The rule set architecture will be described in more detail with respect to panticle 3900 of FIG. 1-C. In an embodiment, SFO rule set panticle 3720 may receive the rule set from Daybreak architecture 3100. In an embodiment, the funds from the account 3030 may not be actually transmitted to SFO rule set panticle 3720, but may be transmitted through ledger transactions. In another embodiment, NU/NE rule set panticle 3650 may implement the rule set from Daybreak architecture 3100 for the funds from the account 3030 that are actually received by SFO rule set panticle 3720.

Referring now to FIG. 1-H, FIG. 1-H shows Foreign Organization/Non-Governmental Organization/Foreign Individual (FO/NGO/FI) entity 3800. FO/NGO/FI 3800 may be one or more of an end point services delivery entity, e.g., a truck driver, a doctor, a supplier, or a (or another) subcontracting entity, or a management entity, e.g., for a set of workers, or any other entity that is to receive payment of funds. In an embodiment, FO/NGO/FI entity 3800 includes panticle 3810. Panticle 3810 is configured to facilitate execution of verification of the reputation and/or the trustworthiness of the FO/NGO/FI 3800, through one or more methods, including but not limited to, verification data (e.g., pictures, video, documents, trusted account numbers), pre-existing relationship, identity confirmation, or one or more other techniques which will be discussed in more detail herein. The verification may continue down the chain to other FO/NGO/FIs that are receiving funds, or, in an embodiment in which FO/NGO/FI 3800 is the endpoint, then panticle 3810 may include taking the action that generates the verification data, or messaging a different entity with instructions to capture the verification data. In an embodiment in which computationally-attributable currency is used to verify transactions, FO/NGO/FI 3800 may close the ledger for that particular unit of currency.

Referring again to FIG. 1-H, FO/NGO/FI 3800 may implement panticle 3810, as previously discussed. Panticle 3810 may include panticle 3812, which, in an embodiment, may provide a reputation score of FO/NGO/FI 3800, or provide a reputation score of a further subcontracted entity, to one or more of the entities shown in FIG. 1 (it is noted that the reputation score is illustrated as provided to SFO 3700, but SFO 3700 may not be present in various embodiments, or FO/NGO/FI 3800 may provide the reputation score to a different entity, or to the Daybreak architecture 3100, regardless of the presence of SFO 3700). The reputation score may be numeric or scaled, or may be review-oriented, objective or subjective, or any combination thereof. In an embodiment, FO/NGO/FI 3800 may have a reputation score that it provides to various entities, but has no control over (e.g., other entities may change the reputation score, e.g., other entities shown in FIG. 1, other FO/NGO/FIs, or some combination thereof). In an embodiment, panticle 3812 may perform management of the reputation score, may verify the reputation score, and may deliver the reputation score.

Referring again to FIG. 1-H, FO/NGO/FI 3800 may implement panticle 3810, as previously discussed. Panticle 3810 may include panticle 3814. Panticle 3814 may, alone or in conjunction with Daybreak architecture 3100, provide past accounting and/or reporting history of FO/NGO/FI 3800, or another entity that reports to and/or has a relationship with FO/NGO/FI 3800. Panticle 3814 may, alone or in conjunction with Daybreak architecture 3100, record, collect, receive, track, or perform other operations related to the accounting and/or reporting history of FO/NGO/FI 3800, for example, previous times that FO/NGO/FI 3800 received a good score for reporting promptly, or a bad score for failing to report promptly, or reporting in a format that was not accepted, or, for example, providing photographic evidence that did not show what was claimed to be shown.

Referring again to FIG. 1-H, FO/NGO/FI 3800 may implement panticle 3820, which may facilitate implementation of acceptance of the acquisition and/or the distribution rule set needed to receive funds. For example, in an embodiment, panticle 3820 may include panticle 3822, which may implement verification of the type of goods and services that are to be provided (e.g., provides the data that will be sent to panticle 3650, which may be implemented by, for example, NU/NE bank 3500). Verification of the goods and/or services (e.g., food, water, potable water, medicine, vaccines, health care services, shelters, clothing, tools, transport services, vehicles, firearms, etc.) may include providing verification that the types of goods and services were the types for which the distribution rule set specifies payment. For example, a part of the distribution rule set may specify that the funds must be spent on vaccinations or organizations that provide vaccinations. In another example, a part of the distribution rule set may specify that certain types of drugs cannot be purchased with funds from the account 3030, e.g., prohibition on Schedule 2 narcotics, for example. The verification may take various forms, e.g., as described in panticle 3600 with respect to FIG. 1-L. In an embodiment, verification may include one or more of photographic evidence, video camera evidence, surveillance camera evidence, satellite camera evidence, GPS verification evidence, RFID/serial number tracking evidence, verification from a trusted and/or known source evidence, or other implementations.

Referring again to FIG. 1-H, in an embodiment, panticle 3820 may include panticle 3824, which may implement verification of where (e.g., at what location) the distribution of goods and/or services will occur. For example, in an embodiment, panticle 3824 may implement that the distribution area may be purely geographical (e.g., “between the two rivers,” or “within a box defined by specific latitudes and longitudes), political (e.g., within the boundaries of a specific foreign country), or data-based (e.g., “only to areas in which the poverty rate is above 85%,” or “only to areas in which HIV infection is above 22%”). For example, a part of the distribution rule set may specify that the funds can only be spent in targeted areas of sub-Saharan Africa.

Referring again to FIG. 1-H, in an embodiment, panticle 3820 may include panticle 3826, which may implement verification of a quantity of goods and/or services that will be distributed. For example, in an embodiment, panticle 3826 may implement an absolute, e.g., “this money must be used to purchase three thousand (3,000) vaccines,”) or relative (e.g., “30% of this money must be used to purchase vaccines) quantity of goods, and provide verification to one or more other entities, e.g., entities depicted in FIG. 1.

Referring again to FIG. 1-H, in an embodiment, panticle 3820 may include panticle 3828, which may implement verification of a source of the goods and/or services that are to be distributed. In an embodiment, the “source” may be an unverified location/supplier, and thus the verification implementation may be to verify that the goods and/or services that are received/performed by the FO/NGO/FI are authentic. In another embodiment, the source may be a verified shipper (e.g., shipping vaccine components from the United States), and panticle 3828 may implement verification that the goods that were alleged to be shipped for distribution have arrived and been verified.

Referring again to FIG. 1-H, in an embodiment, panticle 3820 may include panticle 3829, which may implement the sending of a verification report that details verification that was performed by panticle 3820, e.g., one or more of verifications performed in panticles 3822, 3824, 3826, and 3828. In an embodiment, the verification report may detail the work performed by FO/NGO/FI 3800 if FO/NGO/FI 3800 is the endpoint for service performance/goods delivery. In an embodiment, the verification report may be kept as part of the Daybreak architecture 3100. In another embodiment, Daybreak architecture 3100 may supplement, verify, confirm, or create (and/or prepare for verification) the report, alone or in conjunction with panticle 3820 of FO/NGO/FI 3800.

Referring now to FIG. 1-L, in an embodiment, FIG. 1-L shows implementation of the distribution chain panticle 3600, e.g., by FO/NGO/FI 3800, although in other embodiments, the distribution chain 4600 could be implemented by any of the entities shown in FIG. 1. In an embodiment, panticle 3600 includes panticle 3605, which implements an architecture in which the distributor provides evidence with regard to goods and/or services to FO/NGO/FI 3800. For example, in an embodiment, panticle 4605 may include panticle 3610 for providing photographic evidence of goods and/or services being distributed. As specific examples, although not limiting, panticle 3610 may include one or more of panticle 3612 for implementing a photograph of the delivery vehicle delivering the goods and/or services, photographs of the license plates of the delivery vehicles or the receiving vehicles, photographs of the delivery persons (e.g., with optionally facial recognition algorithms to confirm identity, e.g., as with trusted sources) and panticle 3614 for implementing a photograph of location-identifying markers, e.g., street signs, mountains, and the like.

Referring again to FIG. 1-L, in an embodiment, panticle 3605 may implement an architecture that includes panticle 3620, for location information of goods and services being distributed, e.g., GPS positioning or other location-based services, of, for example, delivery vehicles, goods, medical personnel, delivery personnel, and the like. In an embodiment, panticle 3605 may implement an architecture that includes panticle 3630 for monitoring data associated with distribution of goods and/or services, e.g., various monitoring devices, which may be attached to various goods, e.g., food goods, shipping containers, vaccines, clothing, etc.) The monitoring devices may use near-field communication, or may be RFID tags. In an embodiment, the monitoring may be accomplished through surveillance, e.g., visual, infrared, or some other form, from localized cameras or satellite cameras, for example.

Referring again to FIG. 1-L, in an embodiment, panticle 3605 may implement an architecture that includes panticle 3640, that is, a confirmation form a trusted source, e.g., trusted individual information, e.g., at panticle 3642, such as RFID information, serial number information, and the like, a trusted organization/individual at panticle 3644, or an external audit of trustworthiness at panticle 3646.

Referring now again to FIG. 1-H, in an embodiment, FO/NGO/FI 3800 may provide mechanisms for implementation of payment of the funds from the account 3030 (or other accounts with the funds originally donated, in various embodiments), to the FO/NGO/FI 3800 (and/or its specific representatives). For example, in an embodiment, FO/NGO/FI 3800 may include a panticle 3830 that implements architecture for registering/creating an account with external payment architecture (e.g., Daybreak architecture) 3100. In an embodiment, FO/NGO/FI 3800 may create an account that allows FO/NGO/FI 3800 to receive funds, prepare reports, and ultimately “offboard” the funds from account 3030 (or other accounts) to the persons/entities.

It is noted that, although not explicitly shown (because not required for functionality), in an embodiment, some or all of the entities depicted in FIG. 1, and other entities that may participate in transactions related to the funds from user 3005/organization 3015, may register with the Daybreak architecture 3100. In an embodiment, user 3005, organization 3015, Daybreak architecture 3100, or another entity may impose registration with the Daybreak architecture 3100 as a prerequisite for participating in activities involving the funds contributed by user 3005/organization 3015. In another embodiment, user 3005, organization 3015, Daybreak architecture 3100, or another entity may impose registration with the Daybreak architecture 3100 as a prerequisite for endpoint entities to receive funds, that is, it may be a prerequisite for those persons/entities performing the actual services in the locations for which the funds are specified. In yet another embodiment, registration with Daybreak architecture 3100 may be optional for one or more entities shown in FIG. 1. In still another embodiment, registration with some sort of payment architecture, but not necessarily the Daybreak architecture 3100 (e.g., a competing payment architecture system), may be required.

In an embodiment, referring again to FIG. 1-G, FO/NGO/FI 3800 may include panticle 3832, which may, alone or in conjunction with the Daybreak architecture 3100, verify that any distribution of funds to an endpoint entity (e.g., anyone receiving payment for goods and/or services rendered from the funds) comply with the acquisition and/or distribution rules specified previously by one or more of the entities in FIG. 1. In addition, FO/NGO/FI 3800 may specify further conditions on the distribution rule set, in various embodiments. In an embodiment, FO/NGO/FI 3800 may include panticle 3834, which may request payment from the entity in possession of the funds, e.g., which may be different from the entity indicated by Daybreak architecture 3100 in the ledger transactions. For example, the ledger transactions may show that NU/NE bank 3500 is in possession of 6500 dollars of 10,000 original dollars (the rest being allocated for other entities in the chain), but in actuality the entirety of the 10,000 original dollars may still be with original account 3030. Thus, when the payment is received from the bank account (shown in panticle 3836), only one transfer is needed (from the original bank to the destination), although the ledger transactions show the funds passing between multiple, possibly numerous entities.

Referring now to FIG. 1-D, in an embodiment, FO/NGO/FI 3800 may not have access to a concrete bank. For example, many individual parties outside the United States, particularly in poverty-stricken countries, do not have regular bank accounts or access to bank accounts. Thus, in an embodiment, Daybreak architecture 3100 may interface with a local endpoint payment delivery system, as shown in panticle 3500. For example, local endpoint payment delivery system 4500 may be a money transfer, financing, or microfinancing service, e.g., M-Pesa, or any other service, e.g., an Know Your Customer (KYC) service. In an embodiment, a payment delivery system may receive payment instructions, e.g., from Daybreak architecture 3100, or from one of the other entities in FIG. 1, or a combination thereof, at panticle 3150. In an embodiment, the individual without a bank account may be identified and/or located using the endpoint payment delivery system at panticle 3520 (this panticle includes the process of communicating via the endpoint payment delivery system, e.g., the M-Pesa system). In an embodiment, payment is then effected by an external transfer from one of the entities in FIG. 1 to the endpoint payment delivery system, at panticle 3530, and the payment is delivered to the person through the endpoint payment delivery system at panticle 3540.

Referring now to FIG. 1-I, FIG. 1-I shows some details of the tracking/verification account, which may, in various embodiments, be controlled by Daybreak architecture 3100, or may be implemented at one or more of the entities described throughout FIG. 1, or may be implemented as some combination thereof.

Referring again to FIG. 1-I, in an embodiment, panticle 3100 groups some of the details of the tracking and verification account located inside or outside the United States. In an embodiment, tracking/verification panticle 3100 includes a user query unit 4110. User query unit 4110 may be configured to respond to one or more queries from the user, e.g., user 3005, or another member of the charity organization 3015, or any other representative of an entity depicted in FIG. 1 that has been given access to view the system information.

In an embodiment, user query unit 4110 may respond to example queries from an authorized user. A non-exhaustive list of queries is shown inside panticle 3110. For example, some of the queries handled by user query unit 4110 include a current location of funds query (e.g., a query requesting location data of some or all of the funds, whether via the ledger transactions or the actual accounts where the funds reside), a current account balance query (e.g., a query that requests the current account balance, from one or more of the entities described in FIG. 1), a goods and/or services purchased query (e.g., a query that requests a detailed report of the goods and/or services that have been purchased from the account to date), a goods and/or services distributed query (e.g., a query that requests detail regarding to whom the goods and or services purchased by the account have been distributed), and a verification of goods and/or services distributed query (e.g., a query that shows, for example, if any of the goods and/or services were distributed in a manner that does not follow the specified rule sets).

Referring again to FIG. 1-I, in an embodiment, panticle 3100 may group some of the details of the tracking and/or verification account, which may be located inside or outside the United States. In an embodiment, tracking/verification panticle 3100 may include a recording unit 4120. Recording unit 4120 may record transactions involving the funds in the account 3030, or may record transactions between the various entities shown in FIG. 1, or some combination thereof. In an embodiment, recording unit 4120 may record ledger transactions, actual transactions (e.g., ACH transactions or wire transfers), both, or some combination based on characteristics. In an embodiment, recording unit panticle 3120 may facilitate one or more actions, such as record a location of funds, e.g., at various intervals, for example, a daily recordation, a monthly recordation, a check every hour, a check every second, or any interval whether repeating or nonrepeating. In an embodiment, recording unit panticle 3120 may facilitate one or more actions record a transfer of funds, e.g., each time funds are transferred, e.g., whether an actual funds transfer or a ledger transaction, from any of the entities shown in FIG. 1, to any other entity, or any other transaction that involves account 3030 or the funds contributed by user 3005. The recordation may occur on an ad-hoc basis, or may occur at specific intervals (e.g., every hour, or every day, for example). There may be multiple recordations and/or multiple reports generated in various embodiments.

Continuing to refer to tracking/verification panticle 3100 in FIG. 1-I, in an embodiment, recording unit panticle 3120 may facilitate one or more actions, such as record goods and/or services that are acquired based on funds in the account 3030 or other funds associated with user 3005. For example, when funds are provided for the acquisition of services, whether to the endpoint user (e.g., through a payment system, e.g., M-PESA), or to a middle entity (e.g., a sub contractor), the goods and/or services that are acquired, or that are alleged to have been acquired, may be recorded. This may include various verification techniques which will be discussed in more detail further herein. In an embodiment, recording unit panticle 3120 may facilitate one or more actions, such as recording fees associated with various accounts, e.g., account 3030 as it passes through one more entities in ledger transactions, or actual account fees, e.g., maintenance fees and/or convenience fees for one or more actual accounts held by one or more entities shown in FIG. 1.

Referring again to FIG. 1-I, in an embodiment, panticle 3100 may provide some measure of digital security to one or more transactions, whether actual transactions or ledger transactions, shown in FIG. 1. For example, in an embodiment, digital security unit panticle 3130 may be implemented as a digital security unit that facilitates provision of digital security to the account 3030, to another account, to one or more of the entities shown in FIG. 1-I, to one or more specific transactions, or to some combination thereof. In an embodiment, digital security unit 4130 may operate inside or outside the United States, or a combination thereof. In an embodiment, digital security unit 4130 may include one or more of identity verification, transaction verification, transaction security, and the like. In an embodiment, digital security unit panticle 3130 may use digital currency, e.g., Bitcoin, for one or more transactions. The use of digital currency may be transparent or may be hidden from the participants in the transaction (e.g., the Bitcoin transaction is an underlying layer.

In an embodiment, one or more digital currencies may be used, including, for example, a sub-category of digital currencies commonly referred to as cryptocurrencies. Among the best known cryptocurrencies include, for example, Bitcoin, Ripple, Primecoin, and so forth. Some common features among all of these digital currencies include maintaining a global electronic ledger (e.g., in Bitcoin, this is referred to as a “block chain”) that includes records of all global transactions and a requirement that a relatively complex problem (typically a complex mathematical problem), which in Bitcoin is called “proof of work” be solved whenever a bundle of transactions is to be recorded to the global electronic ledger in order to ensure trustworthiness of the recorded transactions.

In the case of Bitcoins, each transaction requires a new address to be used for each recipient receiving the spent currency. Each transaction is recorded in a transaction block (e.g., a page in global electronic ledger), and a transaction block will at least identify the account/address that the “spent” digital currency originated from. As a result, each unit of currency in the bitcoin eco-system can be traced back to its origin even though Bitcoin is often lauded/despised because of its ability to maintain the anonymity of its participates. This anonymity feature exists partially because the users whose addresses where currencies are being deposited/assigned to remain publically anonymous (e.g., only a participant knows the addresses that belong to the participant). Other types of cryptocurrencies function in similar fashion with some relatively subtle differences.

Although current digital currency systems (e.g., Bitcoin) allows for tracing of individual units of currency (e.g., in Bitcoin, the smallest unit of currency is called a “Satoshi”) back to their origins through their global ledgers (e.g., in Bitcoin, the global ledger is called a “blockchain”), such systems only provide certain basic transactional information (e.g., for a specific transaction, which address was the unit or units of digital currency being reassigned from and which address is the unit or units of digital currency being assigned to, which previous transaction did the unit or units of currency did the currency originate from, and a time stamp). Accordingly, systems and methods are provided herein that employs digital currency that has memory and that is able to “remember,” among other things, information regarding past transactions.

Referring again to FIG. 1-I, in an embodiment, digital security unit panticle 3130 may include one or more implementations of a secure pipeline 4134 that ensures security of a transaction between one or more parties. For example, secure pipeline 4134 may include, as a non-limiting example, a Secure Electronic Transaction (SET) system, or a 3-D secure XML-based protocol. Secure pipeline 4134 may include one or more of such implementations as an electronic wallet, a verified digital certificate, a combination of digital certificates and/or digital signatures. Secure pipeline 4134 may implement or ensure the use of such technologies as Secure Sockets Layer (SSL), Secure Transaction Technology (STT), Secure Hypertext Transfer Protocol (S-HTTP).

Referring again to FIG. 1-I, in an embodiment, tracking/verification panticle 4100 may include a real time tracking/accounting panticle 3140. Real time tracking/accounting panticle 3140 may provide one or more real time functions for, for example, user 3005, although any of the entities shown in FIG. 1 may, in various embodiments, have access to real time tracking and/or real time accounting. As mentioned previously with respect to the panticles as part of the tracking/verificaiton account 4100, real time tracking/accounting panticle 3140 may, in various embodiments, be controlled by Daybreak architecture 3100, or may be implemented at one or more of the entities described throughout FIG. 1, or may be implemented as some combination thereof. It is noted that, here and throughout the specification, the term “real time” also may mean “near real time,” that is, not delivered in what is colloquially considered to be “real time,” but near enough to provide a simulation of real time, due to delays in transmission, processing, or displaying the information, for example.

Referring again to FIG. 1-I, in an embodiment, tracking/verification panticle 4100 may include implementation details for a reward/penalty unit 4150. Reward/penalty unit 4150 may, in various embodiments, be controlled by Daybreak architecture 3100, or may be implemented at one or more of the entities described throughout FIG. 1, or may be implemented as some combination thereof. Reward/penalty unit 4150 may be implemented by a rule set specified by one or more of the entities shown in FIG. 1, including user 3005 and organization 3015. In an embodiment, reward/penalty unit 4150 may use all or a portion of a default rule set specified by Daybreak architecture 3100 or one or more of the other entities. In an embodiment, more than one entity may provide a rule set, and, in an embodiment, multiple rule sets may be honored or attempted to honor. In another embodiment, a first rule set may supersede a second rule set. In an embodiment, reward/penalty unit panticle 3150 may perform one or more of rewarding prompt reporting, penalizing late reporting, returning funds if graft and/or failure to report and/or misuse of funds is detected, and return of funds if goods and/or services are not provided within a particular time frame. Verification of what is happening at endpoints (e.g., through GPS/photographic evidence/etc.) will be discussed in more detail elsewhere in this application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in some embodiments,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A method comprising:
a method substantially as shown and described in the detailed description and/or drawings and/or elsewhere herein.

2. A device comprising:
a device substantially as shown and described in the detailed description and/or drawings and/or elsewhere herein.

3. A method comprising:
a method including one or more of the modules and/or functions described in the detailed description and/or drawings and/or elsewhere herein.

4. (canceled)
